(19) United States
(12) Patent Application Publication
(10) Pub. No.: US 2012/0326817 A1
(43) Pub. Date: Dec. 27, 2012

(54) OPERATION DEVICE AND ELECTRONIC APPARATUS

(75) Inventors: Shun Kayama, Saitama (JP); Yukiko Shimizu, Saitama (JP)

(73) Assignee: SONY CORPORATION, Tokyo (JP)

(21) Appl. No.: 13/527,817

(22) Filed: Jun. 20, 2012

(30) Foreign Application Priority Data
Jun. 27, 2011 (JP) 2011-141633
Jan. 17, 2012 (JP) 2012-007497

(51) Int. Cl. H01H 36/00

(52) U.S. Cl. 335/207

(57) ABSTRACT

An operation device includes: a key top arranged so that part thereof is inserted into a key arrangement hole formed in a casing of an electronic apparatus and being movable in a given direction on the basis of an initial position at the time of operation; a movable magnet attached to the key top; a magnetic body fixed so as to face the movable magnet and giving a force to move the key top in a direction toward the initial position by absorptivity generated between the magnetic body and the movable magnet; a hall device detecting a movement state of the key top due to a magnetic field generated by the movable magnet; and a circuit substrate on which the hall device is mounted.

### CROSS-REFERENCE TO RELATED APPLICATION

The present application claims priority from Japanese Patent Application Nos. JP 2011-141633 filed in the Japanese Patent Office on Jun. 27, 2011, and JP 2012-007497 filed in the Japanese Patent Office on Jan. 17, 2012, the entire contents of which are incorporated herein by reference.

### FIELD

The present disclosure relates to a technical field concerning an operation device and an electronic apparatus. Particularly, the present disclosure relates to a technical field for improving reliability in operation while securing simplification in structure including a key top to which a movable magnet is attached, a magnetic body giving a force for moving the key top in a given direction and a hall device detecting a movement state of the key top.

### BACKGROUND

The operation device for performing given operations is provided in various electronic apparatuses, for example, a recording/reproducing apparatus, an audio recording/reproducing apparatus, an acoustic apparatus, an imaging apparatus, a network communication apparatus, an information processing apparatus such as a personal computer or a PDA (Personal Digital Assistance), a remote control apparatus and the like.

There exists the operation device, for example, configured to have a key top (operation body) and a magnet attached to the key top, in which a movement state of the key top is detected by a sensor when the key top is operated and processing corresponding to the operation is executed (for example, see JP-A-2010-153199 (Patent Document 1)).

In the operation device disclosed in Patent Document 1, a ring-shaped portion (flange portion) is provided in the key top, and a coil spring formed in a ring shape with both ends being connected is arranged on an outer peripheral side of the flange portion. The key top is in an initial position before the operation. When the key top is operated and moved in a radial direction of the flange portion, the coil spring is elastically deformed and a biasing force to move the key top in the direction toward the initial position is applied to the key top by the coil spring.

Accordingly, when the operation with respect to the key to is completed, the key top is moved by the biasing force of the coil spring and returned to the initial position.

As described above, as the key top is operated and moved on the basis of the initial position, the detection by the sensor is performed on the basis of the initial position, as a result, reliability in detection operation is improved and proper processing corresponding to the operation of the key top can be executed.

### SUMMARY

However, as the coil spring is used as a means for returning the key top to the initial position in the operation device disclosed in Patent Document 1, it may be difficult to positively return the key top to the initial position and reduce reliability in operation when the biasing force is reduced by changes due to aging and so on.

Additionally, as the coil spring is formed in the ring shape with both ends being connected, the connection state may be released when the key top is moved and the coil spring is deformed or due to vibration from the outside and the like, which may cause operation failure of the operation device in such cases.

On the other hand, it is desirable to simplify the structure for reducing costs as well as reducing the size in the operation device.

In view of the above, it is desirable to improve the reliability in operation while simplifying the structure.

An embodiment of the present disclosure is directed to an operation device including a key top arranged so that part thereof is inserted into a key arrangement hole formed in a casing of an electronic apparatus and being movable in a given direction on the basis of an initial position at the time of operation, a movable magnet attached to the key top, a magnetic body fixed so as to face the movable magnet and giving a force to move the key top in a direction toward the initial position by absorptivity generated between the magnetic body and the movable magnet, a hall device detecting a movement state of the key top due to a magnetic field generated by the movable magnet, and a circuit substrate on which the hall device is mounted.

Accordingly, the movement state of the key top is detected by the hall device when the key top is operated and the key top is moved to the initial position by the force given by the magnetic body when the operation to the key top is completed in the operation device.

In the above operation device, it is preferable that a circuit pattern to which the hall device is connected is formed on the magnetic body and the magnetic body is provided as the circuit substrate.

As the circuit pattern to which the hall device is connected is formed on the magnetic body and the magnetic body is provided as the circuit substrate, the hall device is mounted on the magnetic body.

In the above operation device, it is preferable that plural spheres positioned in a plane orthogonal to an axial direction of the key arrangement hole and capable of being rolled between the key top and the magnetic body are arranged, the key top is moved in the given direction in a state of being pushed on the plural spheres and the plural spheres are rolled with the movement of the key top.

As the plural spheres positioned in a plane orthogonal to the axial direction of the key arrangement hole and capable of being rolled between the key top and the magnetic body are arranged, the key top is moved in the given direction in a state of being pushed on the plural spheres and the plural spheres are rolled with the movement of the key top, the key top is moved with a small frictional force between the key top and the spheres.

In the above operation device, it is preferable that concave portions for arrangement opening toward the key top, in which the plural spheres are respectively arranged are formed.

As the concave portions for arrangement opening toward the key top, in which the plural spheres are respectively arranged are formed, the movement of the spheres is controlled by the concave portions for arrangement.

In the above operation device, it is preferable that the spheres are made of a magnetic material and magnets for positioning which position the spheres in the concave portions for arrangement are provided.

As the spheres are made of a magnetic material and magnets for positioning which position the spheres in the concave portions for arrangement are provided, the spheres are rolled in a state of being absorbed by the magnets for positioning.

In the above operation device, it is preferable that the plural spheres and the magnets for positioning are arranged on an outer side or an inner side of the movable magnet and the magnetic body in the orthogonal plane.

As the plural spheres and the magnets for positioning are arranged on the outer side or the inner side of the movable magnet and the magnetic body in the orthogonal plane, effects of an electric field generated by the magnets for positioning are small on the electric field generated between the movable magnet and the magnetic body.

In the above operation device, it is preferable that the magnetic body is attached to the circuit substrate, a device arrangement hole is formed on the magnetic body and the hall device is arranged in the device arrangement hole.

As the magnetic body is attached to the circuit substrate, the device arrangement hole is formed on the magnetic body and the hall device is arranged in the device arrangement hole, the hall device and the magnetic body do not interfere with each other.

In the above operation device, it is preferable that concave portions for insertion opening toward the spheres are formed in the key top, and at least part of the spheres is inserted in the concave portions for insertion.

As the concave portions for insertion opening toward the spheres are formed in the key top, and at least part of the spheres is inserted in the concave portions for insertion, the key top is positioned closer to the circuit substrate by the depth of the concave portions for insertion.

In the above operation device, it is preferable that part of the circuit substrate is formed as sphere arrangement portions in which the spheres are arranged, and concentric traces are formed in the sphere arrangement portions.

As part of the circuit substrate are formed as the sphere arrangement portions in which the spheres are arranged, and the concentric traces are formed in the sphere arrangement portions, an operating feeling is transmitted to an operator through the spheres and the key top when the spheres are rolled in sphere arrangement portions.

In the above operation device, it is preferable that the key top includes an operated body movable in a direction orthogonal to the axial direction of the key arrangement hole and a pressed operation portion supported by the operated body so as to be movable in the axial direction of the key arrangement hole, the pressed operation portion is moved between a non-operation position in which operation is not performed and an operation position in which operation is performed and given processing is performed, and when the pressed operation portion is pushed and moved to the operation position, different processing from processing executed when the operated body is operated is performed.

As the pressed operation portion is moved between the non-operation position and the operation position and, when the pressed operation portion is pushed and moved to the operation position, different processing from processing executed when the operated body is operated is performed.

It is preferable that plural connection terminals are formed on the circuit substrate, a plate spring having conductivity is arranged on the circuit substrate, the plate spring is elastically deformed and touches the plural connection terminals when the pressed operation portion is operated to thereby connect the plural connection terminals to one another through the plate spring, and the plate spring is elastically returned when the operation with respect to the pressed operation portion is released to thereby release the connection between the plural connection terminals as well as move the pressed operation portion to the non-operation position by the plate spring.

As the plate spring is elastically deformed and touches the plural connection terminals to thereby connect the plural connection terminals to one another through the plate spring, and the plate spring is elastically returned and the pressed operation portion is moved to the non-operation position, connection between the plural connection terminals and movement of the pressed operation portion to the non-operation position are performed by the plate spring.

In the above operation device, it is preferable that the magnetic body is attached to the circuit substrate, a spring arrangement hole is formed in the magnetic body and the plate spring is arranged in the spring arrangement hole.

As the magnetic body is attached to the circuit substrate, a spring arrangement hole is formed in the magnetic body and the plate spring is arranged in the spring arrangement hole, the plate spring and the magnetic body do not interfere with each other.

In the above operation device, it is preferable that a convex portion protruding toward the movable magnet is provided in the magnetic body and an N-pole and a S-pole of the movable magnet are magnetized in the same direction as a direction in which the movable magnet and the magnetic body are aligned.

As the convex portion protruding toward the movable magnet is provided in the magnetic body and the N-pole and the S-pole of the movable magnet are magnetized in the same direction as the direction in which the movable magnet and the magnetic body are aligned, a force in the direction in which the center of the movable magnet becomes closest to the convex portion is given by the movable magnet.

In the above operation device, it is preferable that the movable magnet and the magnetic body are formed in a ring shape.

As the movable magnet and the magnetic body are formed in the ring shape, arrangement space can be secured inside the movable magnet and the magnetic body.

In the above operation device, it is preferable that different poles are alternately magnetized in a circumferential direction in the movable magnet, and a magnet in which different poles are alternately magnetized in the circumferential direction is used as the magnetic body.

As different poles are alternately magnetized in the circumferential direction in the movable magnet and the magnet in which different poles are alternately magnetized in the circumferential direction is used as the magnetic body, apsorptivity between the movable magnet and the magnetic body is increased.

Another embodiment of the present disclosure is directed to an electronic apparatus including a casing in which a key arrangement hole is formed, a key top arranged so that part thereof is inserted into the key arrangement hole and being movable in a given direction on the basis of an initial position at the time of operation, a movable magnet attached to the key top, a magnetic body fixed so as to face the movable magnet and giving a force to move the key top in a direction toward the initial position by absorptivity generated between the magnetic body and the movable magnet, a hall device detecting a movement state of the key top due to a magnetic field generated by the movable magnet, and a circuit substrate on which the hall device is mounted.

Accordingly, the movement state of the key top is detected by the hall device when the key top is operated and the key top is moved to the initial position by the force given by the magnetic body when the operation to the key top is completed in the electronic apparatus.

The operation device according to the embodiment of the present disclosure includes a key top arranged so that part thereof is inserted into a key arrangement hole formed in a casing of an electronic apparatus and being movable in a given direction on the basis of an initial position at the time of operation, a movable magnet attached to the key top, a magnetic body fixed so as to face the movable magnet and giving the force to move the key top in a direction toward the initial position by absorptivity generated between the magnetic body and the movable magnet, a hall device detecting a movement state of the key top due to a magnetic field generated by the movable magnet, and a circuit substrate on which the hall device is mounted.

Therefore, the key top can be positively returned when the operation to the key top is completed, which improves the reliability in operation while securing the simplification in structure.

According to one embodiment of the present disclosure, the circuit pattern to which the hall device is connected is formed on the magnetic body and the magnetic body is provided as the circuit substrate.

Therefore, the number of components is small, which downsizes the device and simplifies the structure.

According to one embodiment of the present disclosure, plural spheres positioned in a plane orthogonal to an axial direction of the key arrangement hole and capable of being rolled between the key top and the magnetic body are arranged, the key top is moved in the given direction in a state of being pushed on the plural spheres and the plural spheres are rolled with the movement of the key top.

Therefore, the key top is smoothly moved when the operation is performed to the key top, which improves operationality.

According to one embodiment of the present disclosure, concave portions for arrangement opening toward the key top in which the plural spheres are respectively arranged are formed.

Therefore, as excessive movement of the spheres is controlled by the concave portions for arrangement, the contact state between the spheres and the key top is not released and good operationality of the key top can be constantly secured.

According to one embodiment of the present disclosure, the spheres are made of a magnetic material and magnets for positioning which position the spheres in the concave portions for arrangement are provided.

Therefore, the spheres are not rolled independent of the operation with respect to the key top, thereby constantly securing given operating feeling at the time of operating the key top and improving operationality.

According to one embodiment of the present disclosure, the plural spheres and the magnets for positioning are arranged on an outer side or an inner side of the movable magnet and the magnetic body in the orthogonal plane.

Therefore, effects of a magnetic field generated by the magnets for positioning are small on a magnetic field generated between the movable magnet and the magnetic body, and effects on the absorptivity between the magnetic body and the movable magnet by the magnets for positioning are small, therefore, it is possible to improve reliability of absorption operation of the magnetic body with respect to the movable magnet.

According to one embodiment of the present disclosure, the magnetic body is attached to the circuit substrate, a device arrangement hole is formed on the magnetic body and the hall device is arranged in the device arrangement hole.

Therefore, simplification in structure and reduction in thickness of the operation device can be realized.

According to one embodiment of the present disclosure, concave portions for insertion opening toward the spheres are formed in the key top, and at least part of the spheres is inserted in the concave portions for insertion.

Therefore, it is possible to allow the key top to be close to the circuit substrate by the depth of the concave portions for insertion, which can further reduce the thickness of the operation device.

According to one embodiment of the present disclosure, part of the circuit substrate is formed as sphere arrangement portions in which the spheres are arranged, and concentric traces are formed in the sphere arrangement portions.

Therefore, as operating feeling is transmitted to an operator through the spheres and the key top, the operator can obtain good operating feeling.

According to one embodiment of the present disclosure, the key top includes an operated body movable in a direction orthogonal to the axial direction of the key arrangement hole and a pressed operation portion supported by the operated body so as to be movable in the axial direction of the key arrangement hole, the pressed operation portion is moved between a non-operation position in which operation is not performed and an operation position in which operation is performed and given processing is performed, and when the pressed operation portion is pushed and moved to the operation position, different processing from processing executed when the operated body is operated is performed.

Therefore, as different processing is executed in accordance with the operation by the operated body in the key top and the operation by the pressed operation portion, it is possible improving operationality while downsizing the operation device.

According to one embodiment of the present disclosure, plural connection terminals are formed on the circuit substrate, a plate spring having conductivity is arranged on the circuit substrate, the plate spring is elastically deformed and touches the plural connection terminals when the pressed operation portion is operated to thereby connect the plural connection terminals to one another through the plate spring, and the plate spring is elastically returned when the operation with respect to the pressed operation portion is released to thereby release the connection between the plural connection terminals as well as move the pressed operation portion to the non-operation position by the plate spring.

Therefore, as the plate spring has two functions which are a function of connecting plural connection terminals and a function of moving the pressed operation portion to the non-operation position, a good operation state of the pressed operation portion can be secured with the simple mechanism while reducing the number of components.

According to one embodiment of the present disclosure, the magnetic body is attached to the circuit substrate, a spring arrangement hole is formed in the magnetic body and the plate spring is arranged in the spring arrangement hole.

Therefore, simplification in structure and reduction in thickness of the operation device can be realized.

According to one embodiment of the present disclosure, a convex portion protruding toward the movable magnet is provided in the magnetic body, and an N-pole and a S-pole of the movable magnet are magnetized in the same direction as a direction in which the movable magnet and the magnetic body are aligned.

Therefore, the key top can be positively returned to the original position before operation when the operation with respect to the key top is released.

According to one embodiment of the present disclosure, the movable magnet and the magnetic body are formed in a ring shape.

Therefore, it is possible to downsize the operation device as well as simplify the structure while securing good absorptivity between the movable magnet and the magnetic body.

According to one embodiment of the present disclosure, different poles are alternately magnetized in a circumferential direction in the movable magnet, and a magnet in which different poles are alternately magnetized in the circumferential direction is used as the magnetic body.

Therefore, it is possible to secure a stable movement state to the initial position and improve reliability in operation of the operation device while simplifying the structure of the movable magnet and the magnetic body to thereby downsize the device.

The electronic apparatus according to the embodiment of the present disclosure includes a casing in which a key arrangement hole is formed, a key top arranged so that part thereof is inserted into the key arrangement hole and movable in a given direction on the basis of an initial position at the time of operation, a movable magnet attached to the key top, a magnetic body fixed so as to face the movable magnet and giving the force to move the key top in a direction toward the initial position by absorptivity generated between the magnetic body and the movable magnet, a hall device detecting a movement state of the key top due to a magnetic field generated by the movable magnet, and a circuit substrate on which the hall device is mounted.

Therefore, the key top can be positively returned to the initial position when the operation with respect to the key top is completed, which improves reliability in operation while securing simplification in structure.

### BRIEF DESCRIPTION OF THE DRAWINGS

FIG. 1 shows an operation device and an electronic apparatus according to an embodiment of the present disclosure with FIG. 2 to FIG. 28, which is a plan view of the electronic apparatus;

FIG. 2 is an exploded perspective view of the operation device;

FIG. 3 is an enlarged cross-sectional view of the operation device;

FIG. 4 is an enlarged plan view of the operation device;

FIG. 5 is an enlarged perspective view showing a movable magnet and a magnetic body;

FIG. 6 is an enlarged perspective view showing an example of the movable magnet and a magnetic body in which holes are formed;

FIG. 7 is an enlarged perspective view showing an example of the movable magnet and a magnetic body in which protrusions are provided;

FIG. 8 is an enlarged perspective view showing an example of the movable magnet and a magnetic body including plural members;

FIG. 9 is an enlarged perspective view showing an example of a movable magnet including plural members and the magnetic body;

FIG. 10 is an enlarged perspective view showing an example of the movable magnet including plural members and the magnetic body including plural members;

FIG. 11 is a schematic plan view showing positions of respective portions in an initial position;

FIG. 12 is an enlarged cross-sectional view showing a state in which an operated body of a key top is operated;

FIG. 13 is an enlarged cross-sectional view showing a state in which a pressed operation portion of the key top is operated;

FIG. 14 is an enlarged plan view showing an example in which the key top is moved in a circumferential direction along a shape of a key arrangement hole;

FIG. 15 is an enlarged plan view showing an example in which the key top is rotated in the initial position;

FIG. 16 is an enlarged plan view showing an example in which the key top and the key arrangement hole are formed in a triangular shape;

FIG. 17 is an enlarged plan view showing an example in which the key top and the key arrangement hole are formed in a quadrangular shape;

FIG. 18 is an enlarged cross-sectional view showing an example in which the key top is moved in a direction along a spherical surface;

FIG. 19 is an enlarged plan view showing an example in which the key top moves in two directions;

FIG. 20 is an enlarged cross-sectional view showing the example in which the key top moves in two directions;

FIG. 21 is an enlarged cross-sectional view showing an operation device according to a first modification example in which respective portions are arranged on one surface of a circuit substrate;

FIG. 22 is an enlarged cross-sectional view showing an operation device according to a second modification example in which a housing is not provided;

FIG. 23 is an enlarged cross-sectional view showing an example in which concave portions for insertion are formed in the operation device according to the second modification example;

FIG. 24 shows an operation device according to a third modification example with FIG. 25 in which traces on which spheres are touched are formed on the circuit substrate, which is an enlarged cross-sectional view showing a state in which the sphere climbs onto a trace;

FIG. 25 is an enlarged cross-sectional view showing a state in which the sphere falls between traces;

FIG. 26 is an enlarged cross-sectional view showing an operation device according to a fourth modification example in which the circuit substrate is formed as the magnetic body;

FIG. 27 is an enlarged cross-sectional view showing an operation device according to a fifth modification example including the magnetic body which is provided with a convex portion; and

FIG. 28 is an enlarged cross-sectional view showing an operation device in which the key top is operated by being slid to the housing.

### DETAILED DESCRIPTION

Hereinafter, an embodiment of the operation device and the electronic apparatus will be explained with reference to the attached drawings.

In the embodiment which will be explained below, the electronic apparatus according to the present technique is applied to a remote control apparatus and the operation device according to the present technique is applied to an operation device provided in the remote control apparatus.

However, the application range of the present technique is not limited to the remote control apparatus and the operation device provided therein. The electronic apparatus according to the present technique can be widely applied to other various electronic apparatuses, for example, a recording/reproducing apparatus such as a disc recording/reproducing apparatus using a recording medium, an audio recording/reproducing apparatus performing recording/reproduction of audio, an imaging apparatus taking images or video, a network communication apparatus performing unidirectional or bi-directional transmission/reception, an information processing apparatus such as a personal computer or a PDA (Personal Digital Assistance) and the like. The operation device according to the present technique can be widely applied to operation devices provided in these various electronic apparatuses.

In the following explanation, directions of front and back, up and down as well as right and left are shown by determining a direction to which an operation surface of the remote control apparatus faces as an upper direction and a direction toward which the remote control apparatus performs operation as a front direction. The directions of front and back, up and down as well as right and left are determined for convenience of explanation, and are not limited to these directions in the embodiment of the present disclosure.

### [Schematic Structure of Electronic Apparatus]

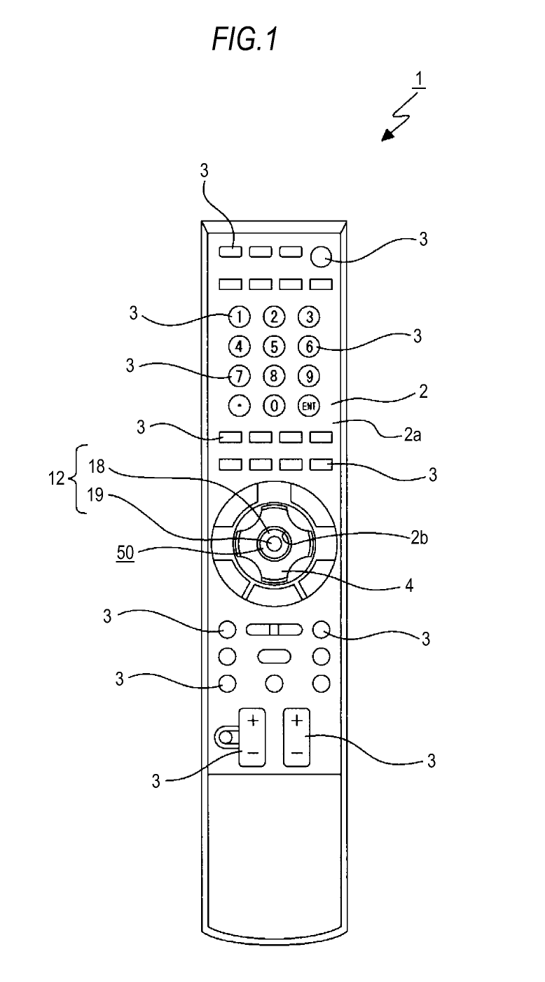

An electronic apparatus (remote control apparatus) is formed by necessary respective portions arranged on a flat casing 2 extending back and forth (see FIG. 1). The electronic apparatus 1 is used for performing remote control using infrared light with respect to, for example, a television receiver.

An upper surface of the casing 2 is formed as an operation surface 2a on which various types of operation portions 3, 3, . . . , are arranged. As the operation portions 3, 3, . . . , for example, channel selection buttons, a volume adjustment knob, a screen-mode change button, function selection buttons and so on are provided.

On the operation surface 2a of the casing 2, a key arrangement hole 2b piercing in an up-and-down direction is formed. An operation key 4 is arranged around the key arrangement hole 2b on the operation surface 2a. The operation key 4 can be operated in, for example, four directions of front and back as well as right and left, having functions of, for example, fast-forwarding or rewinding images reproduced on a display screen of the television receiver, performing movement between thumbnails and so on.

The television receiver is, for example, a so-called internet television on which programs can be viewed through internet connection, in which icons and an arrow (cursor) are displayed on the display screen. When the arrow is moved onto an icon and the icon is clicked on the display screen, a function of the icon which has been clicked can be executed.

### [Structure of Operation Device]

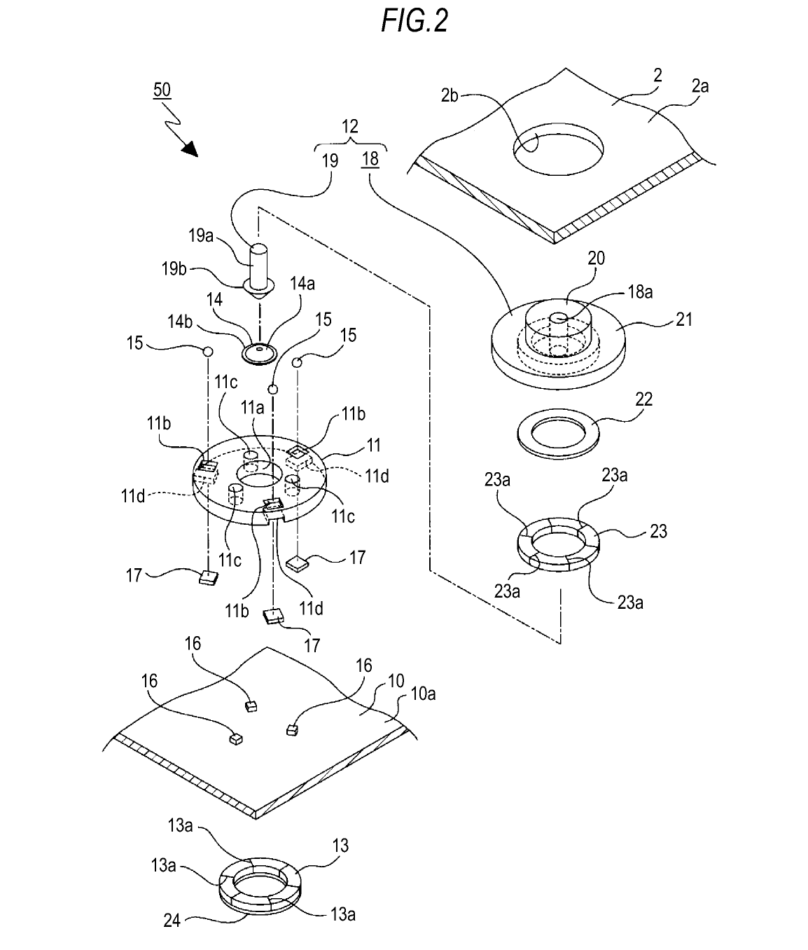

An operation device 50 is formed by necessary respective portions arranged on both surfaces of an upper surface 10a and an lower surface 10b of a circuit substrate 10, in which part of the device is inserted into the key arrangement hole 2b of the casing 2 (see FIG. 2 to FIG. 4).

The circuit substrate 10 is arranged inside the casing 2 and a not-shown circuit pattern is formed in the circuit substrate 10. On the upper surface 10a of the circuit substrate 10, not-shown plural connection terminals are formed.

The operation device 50 includes a housing 11, a key top 12 and a magnetic body 13.

The housing 11 is formed in an approximately ring shape, which is attached to the upper surface 10a of the circuit substrate 10. A central hole of the housing 11 is formed as a spring arrangement hole 11a. The plural connection terminals formed on the upper surface 10a of the circuit substrate 10 are positioned in an outer peripheral portion of the spring arrangement hole 11a in a state where the housing 11 is attached to the upper surface 10a of the circuit substrate 10.

Concave portions for arrangement 11b, 11b and 11b opening upward are formed in the outer peripheral portion of the housing 11. The concave portions for arrangement 11b, 11b and 11b are positioned apart from one another at equal intervals in a circumferential direction. In an inner peripheral portion of the housing 11, device arrangement holes 11c, 11c and 11c piercing in the up-and-down direction are formed. The device arrangement holes 11c, 11c and 11c are positioned apart from one another at equal intervals in the circumferential direction.

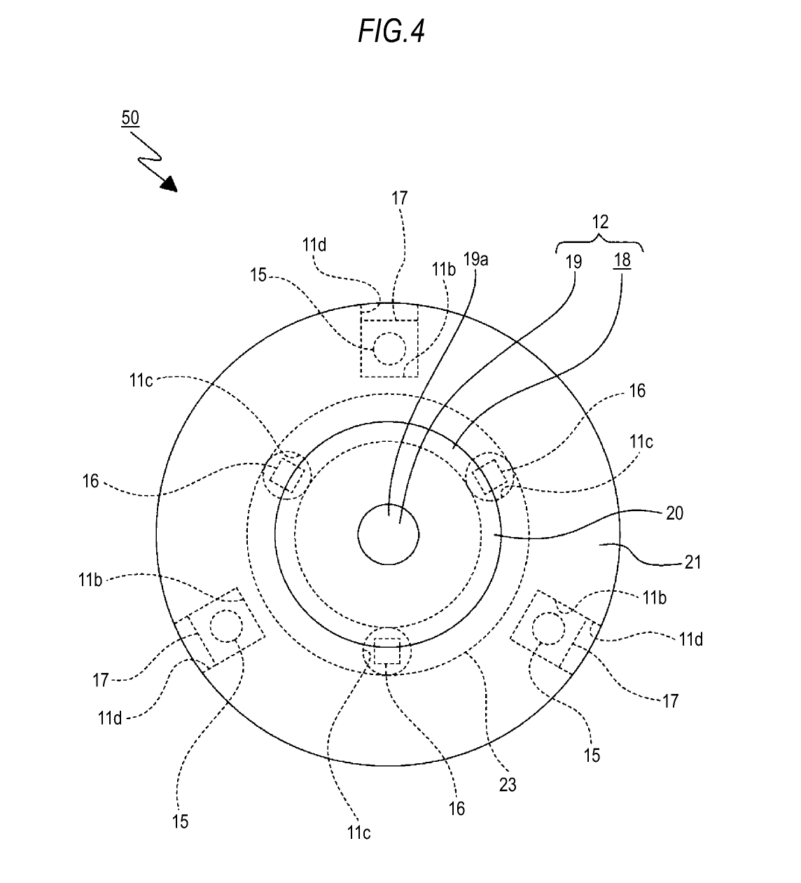

The concave portions for arrangement 11b, 11b, 11b and the device arrangement holes 11c, 11c, 11c are formed at positions shifted from one another in the circumferential direction. The concave portions for arrangement 11b, 11b, 11b and the device arrangement holes 11c, 11c, 11c are alternately positioned at equal intervals respectively in the circumferential direction (see FIG. 4).

In the outer peripheral portion of the housing 11, attachment concave portions 11d, 11d and 11d are formed just under the concave portions for arrangement 11b, 11b, 11b. The attachment concave portions 11d, 11d and 11d open downward as well as outward (see FIG. 2 to FIG. 4).

In the spring arrangement hole 11a of the housing 11, a plate spring 14 is arranged. The plate spring 14 is made of a material having conductivity, in which a portion other than an outer peripheral portion is formed as an elastic deformation portion 14a formed to have a shape of an approximately hemisphere surface which is convex upward and the outer peripheral portion is formed as a connection portion 14b formed in an approximately ring shape.

The connection portion 14b does not touch the connection terminals formed on the circuit substrate 10 in a state where the elastic deformation portion 14a of the plate spring 14 is not elastically deformed. When the elastic deformation portion 14a is elastically deformed, the connection portion 14b touches the plural connection terminals and respective connection terminals are connected to one another by the plate spring 14.

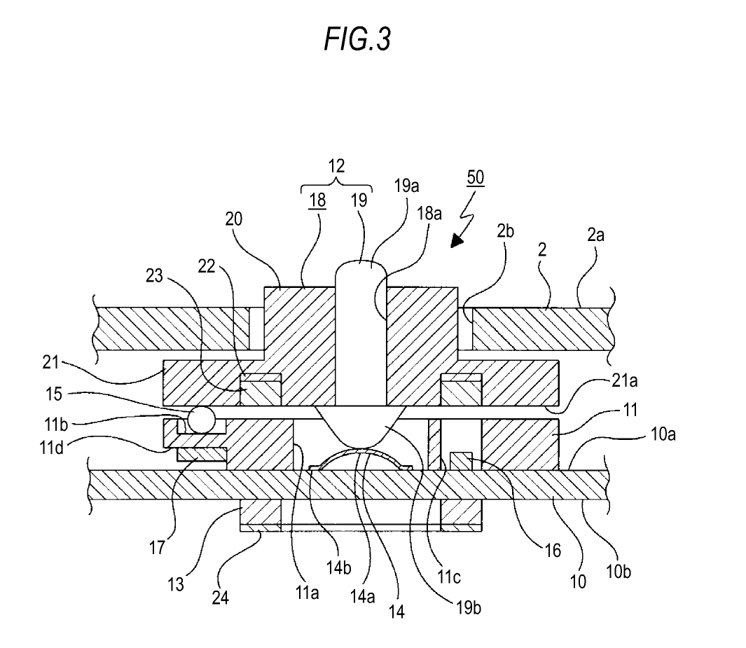

In the concave portions for arrangement 11b, 11b and 11b of the housing 11, spheres 15, 15 and 15 made of a magnetic material are respectively arranged so as to be rolled. The sphere 15 can be moved in an arbitrary direction by being rolled in the concave portion for arrangement 11b, in which part thereof protrudes upward from the concave portion for arrangement 11b (see FIG. 3).

In the device arrangement holes 11c, 11c and 11c of the housing 11, hall devices 16, 16 and 16 are respectively arranged (see FIG. 2 to FIG. 4). The hall devices 16 are mounted on the circuit pattern formed on the circuit substrate 10, and drive current is supplied to the hall devices 16 from a not-shown power supply circuit through the circuit substrate 10.

Magnets for positioning 17, 17 and 17 are attached to the attachment concave portions 11d, 11d and 11d of the housing 11. The magnets for positioning 17 are formed in a plate shape and have a function of absorbing the spheres 15. Therefore, the spheres 15 are prevented from being dropped off from the concave portions for arrangement 11b by the magnets for positioning 17 as well as pulled to the center of each of the concave portions for arrangement 11b.

The key top 12 includes an operated body 18 and a pressed operation portion 19 supported by the operated body 18 so as to move in the up-and-down direction.

The operated body 18 includes an operated portion 20 positioned on an upper side and formed in a column shape and a disc-shaped magnet attachment portion 21 provided so as to continue from a lower side of the operated portion 2. The operated portion 20 and the magnet attachment portion 21 are positioned on the same axis. A supporting hole 18a piercing in the up-and-down direction is formed in the center of the operated body 18. A diameter of the operated body 20 is formed to be slightly smaller than a diameter of the key arrangement hole 2b formed in the casing 2.

A yoke 22 and a movable magnet 23 are attached to the magnet attachment portion 21 in a state of being coupled in the up-and-down direction. The yoke 22 and the movable magnet 23 are respectively formed in a ring shape and attached in a state of being buried in the magnet attachment portion 21. A lower surface 21a of the magnet attachment portion 21 and a lower surface of the movable magnet 23 are positioned on the same plane.

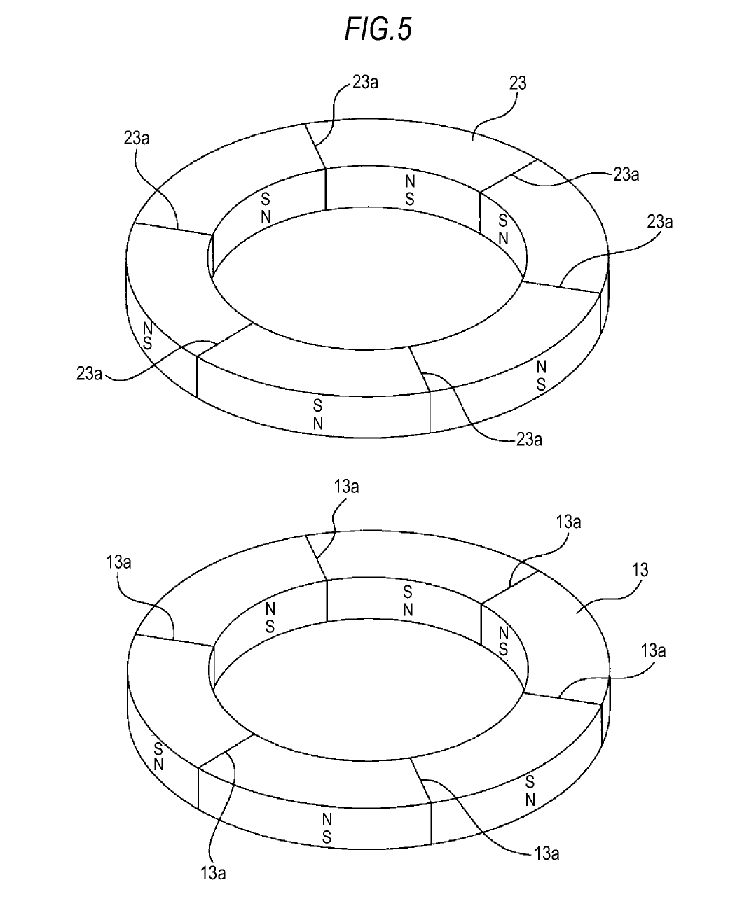

In the movable magnet 23, for example, the N-pole and the S-pole are magnetized in the up-and-down direction and six-poles are magnetized in the circumferential direction (see FIG. 5). Boundaries between which polarity changes in the circumference direction of the movable magnet 23 are defined as neutral lines 23a, 23a, . . . .

The pressed operation portion 19 includes an operated axis portion 19a and a controlled portion 19b protruding outward from a lower end of the operated axis portion 19a (see FIG. 2 and FIG. 3). The pressed operation portion 19 is inserted into the supporting hole 18a of the operated body 18 from below and can be moved in the up-and-down direction with respect to the operated body 18 (see FIG. 3). The pressed operation portion 19 can be moved with respect to the operated body 18 between a non-operation position (an upper movement end) which is a position before operated and an operation position (a lower movement end) which is a position after operated.

The movement of the pressed operation portion 19 in the upper direction with respect to the operated body 18 is controlled by the controlled body 19b. An upper end of the pressed operation portion 19 protrudes upward from the operated body 18 in a state of being supported by the operated body 18.

The key top 12 is arranged so that the operated portion 20 is inserted into the key arrangement hole 2b formed in the casing 2 and so that the magnet attachment portion 21 is positioned inside the casing 2. The key top 12 is arranged so that the lower surface 21a touched the spheres 15, 15 and 15 from above. The pressed operation portion 19 is arranged so that a lower surface touches the plate spring 14.

The magnetic body 13 is attached to the lower surface 10b of the circuit substrate 10. A magnetic material such as a magnet or iron is used for the magnetic body 13. The magnetic body 13 is formed in a ring shape, and a yoke member 24 having a ring shape is attached to a lower surface of the magnetic body 13.

When the magnet is used for the magnetic body 13, for example, the N-pole and the S-pole are magnetized in the up-and-down direction and six-poles are magnetized in the circumferential direction in the magnetic body 13 (see FIG. 5). Boundaries between which polarity changes in the circumference direction of the magnetic body 13 are defined as neutral lines 13a, 13a, . . . .

The above movable magnet 23 and the magnetic body exist at positions facing each other in the up-and-down direction. The magnets for positioning 17, 17 and 17 performing positioning of the spheres 15, 15 and 15 are positioned on an outer peripheral side of the movable magnets 23 and the magnetic body 13. The magnets for positioning 17, 17 and 17 can be positioned on an inner peripheral side of the movable magnets 23 and the magnetic body 13.

As described above, the movable magnets 23 and the magnetic body 13 exist at positions facing each other in the in the up-and-down direction, therefore, absorptivity occurs between them. As the magnetic body 13 is attached to the circuit substrate 10 in a fixed state, the movable magnet 23 is pulled to the magnetic body 13 due to absorptivity when the key top 12 is operated and moved. Accordingly, the lower surface 21a of the key top 12 is pushed on the spheres 15, 15 and 15, and the spheres 15, 15 and 15 are pushed on the housing 11 in the concave portions for arrangement 11b, 11b and 11b.

The movable magnet 23 is pulled to the magnetic body 13 as described above in a manner that a pole on the lower side of the movable magnet 23 is absorbed (sucked) to a different pole on the upper side of the magnetic body 13. Therefore, the N-pole and the S-pole of the movable magnet 23 are pulled to the S-pole and the N-pole of the magnetic body 13 respectively so that the neutral lines 23a, 23a, . . . of the movable magnet 23 correspond to the neutral lines 13a, 13a, . . . of the magnetic body 13 in the up-and-down direction.

As described above, the movable magnet 23 and the magnetic body 13 are positioned so as to face each other in the up and down direction and the movable magnet 23 is pulled to the magnetic body 13 in the operation device 50, in which the magnets for positioning 17, 17 and 17 are positioned on the outer peripheral side or on the inner peripheral side of the movable magnets 23 and the magnetic body 13.

Accordingly, effects of a magnetic field generated by the magnets for positioning 17, 17 and 17 are small on a magnetic field generated between the movable magnet 23 and the magnetic body 13, and effects on the absorptivity between the magnetic body 13 and the movable magnet 23 by the magnets for positioning 17, 17 and 17 are small, therefore, it is possible to improve reliability of absorption operation of the magnetic body 13 with respect to the movable magnet 23.

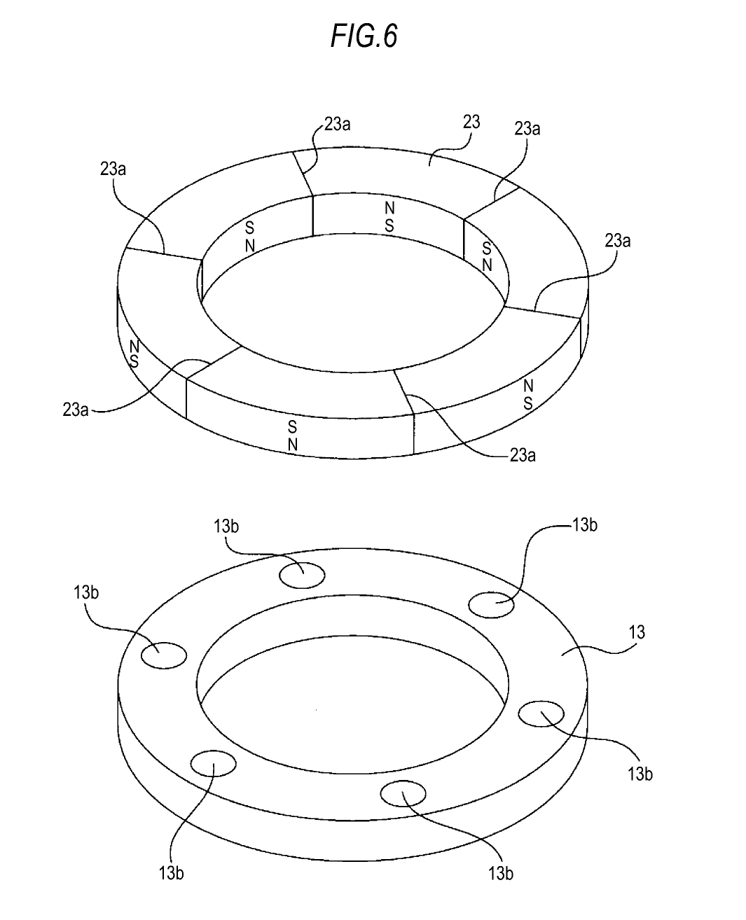

When the magnetic body 13 is made of a magnetic material such as iron, holes 13b, 13b, . . . , are formed apart from one another at equal intervals in the circumferential direction of the magnetic body 13 (see FIG. 6). The absorptivity with respect to the movable magnet 23 is lower in portions where the holes 13b, 13b, . . . are formed than in other portions of the magnetic body 13, and the movable magnet 23 is pulled to the magnetic body 13 so that the neutral lines 23a, 23a, . . . correspond to the holes 13b, 13b, . . . in the up-and-down direction.

When the magnetic body 13 is made of a magnetic material such as iron, it is preferable that a concave portion is formed in the magnetic body 13 for partially reducing the absorptivity with respect to the movable magnet 23.

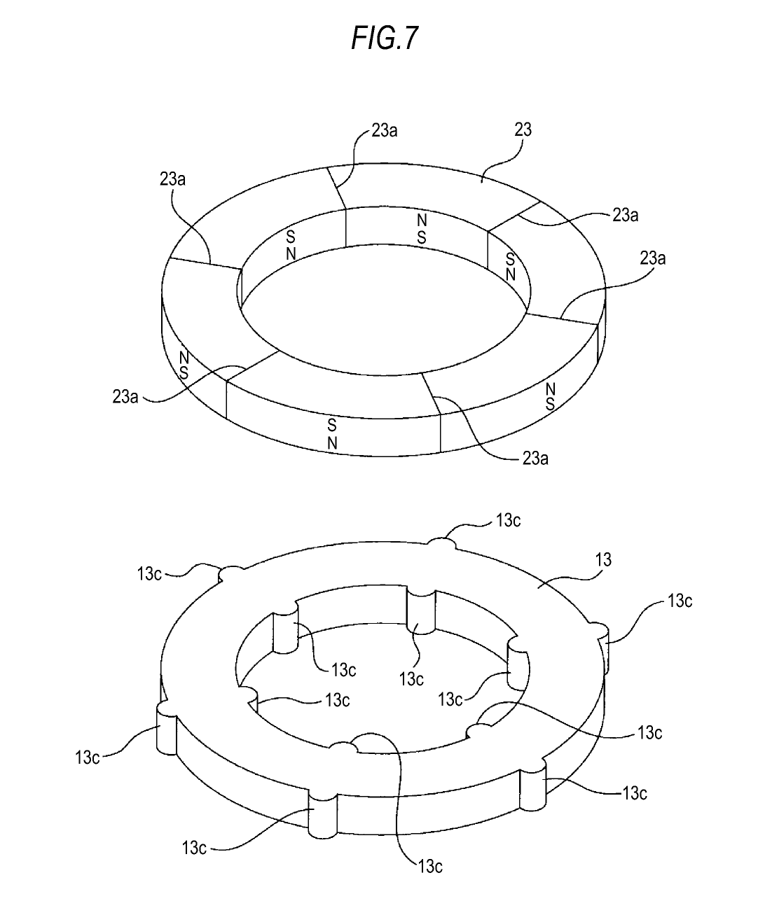

Additionally, when the magnetic body 13 is made of a magnetic material such as iron, it is also preferable that protrusions 13c, 13c, . . . protruding outward or inward are provided apart from one another at equal intervals in the circumferential direction of the magnetic body 13 (see FIG. 7). The absorptivity with respect to the movable magnet 23 is higher in portions where the protrusions 13c, 13c, . . . are formed than in other portions of the magnetic body 13, and the movable magnet 23 is pulled to the magnetic body 13 so that the neutral lines 23a, 23a, . . . correspond to centers between the protrusions 13c, 13c, . . . in the up-and-down direction.

In the relation between the movable magnet 23 and the magnetic body 13, the shape of the movable magnet 23 and the magnetic body 13 is not limited to the ring shape as long as they have shapes in which the center of the movable magnet 23 corresponds to the center (midpoint) of the magnet body 13 such as polygonal shapes, and it is not always necessary that sizes of the movable magnet 23 and the magnetic body 13 are equal.

However, when both the movable magnet 23 and the magnetic body 13 are formed in the ring shape as described above, arrangement space for arranging other members inside the movable magnet 23 and the magnetic body 13 is secured and the operation device 50 can be downsized as well as the structure can be simplified while securing good absorptivity between the movable magnet 23 and the magnetic body 13.

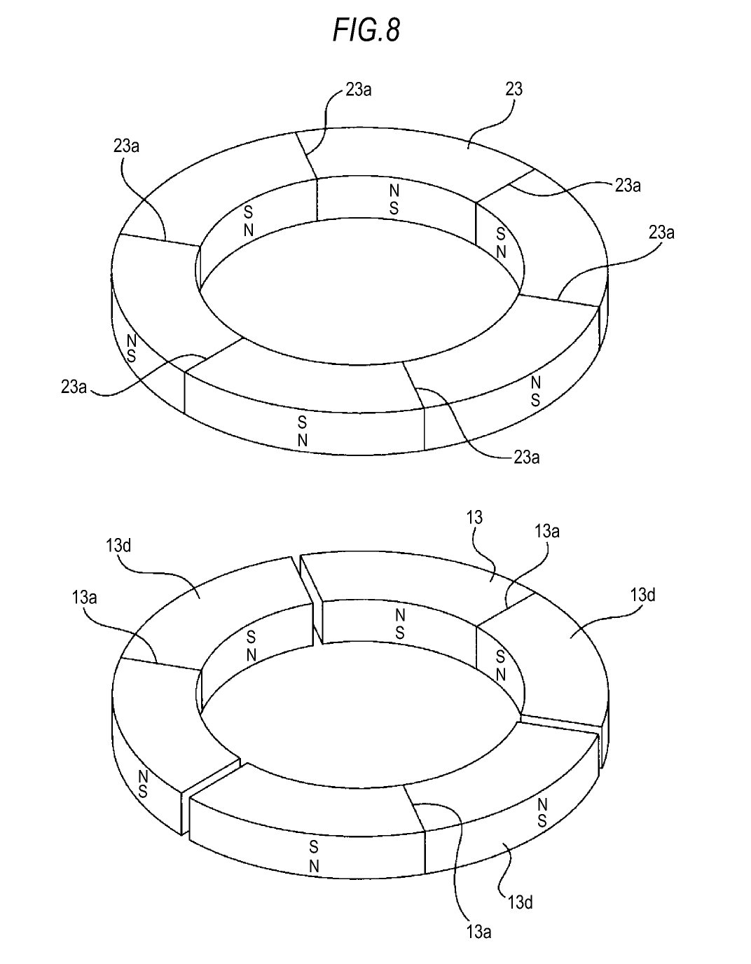

Additionally, it is not always necessary that the magnetic body 13 using the magnet or a magnetic material is formed by one member, and for example, the magnetic body 13 can be formed by plural members 13d, 13d, . . . separated in the circumferential direction as shown in FIG. 8.

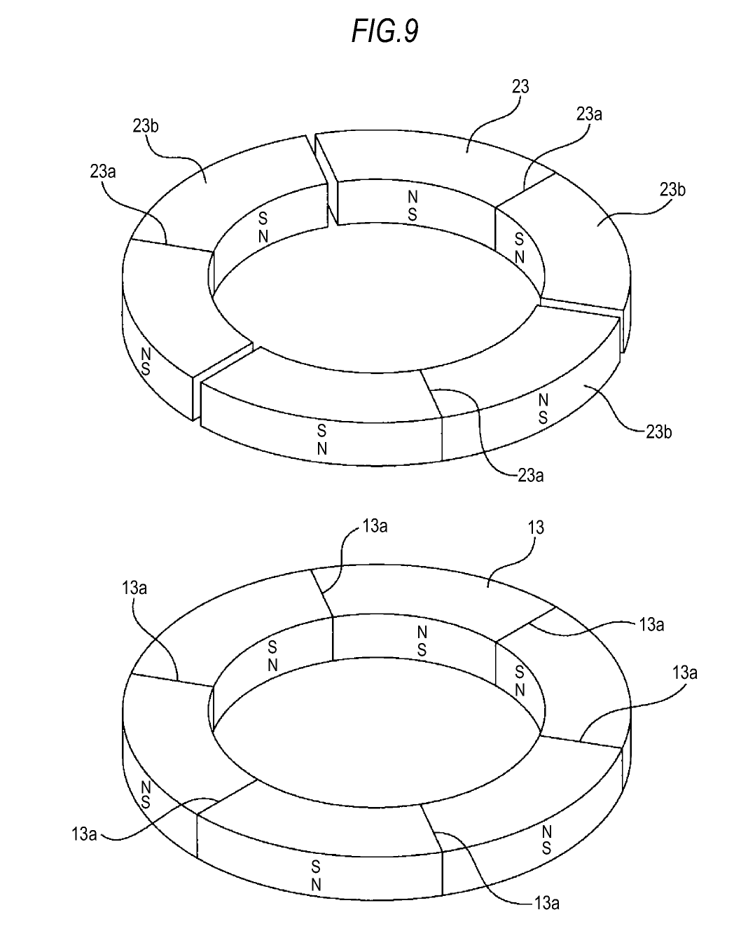

Furthermore, the magnetic body 13 using the magnet or a magnetic material is formed by one member and the movable magnet 23 is formed by plural members 23b, 23b, . . . separated in the circumferential direction as shown in FIG. 9.

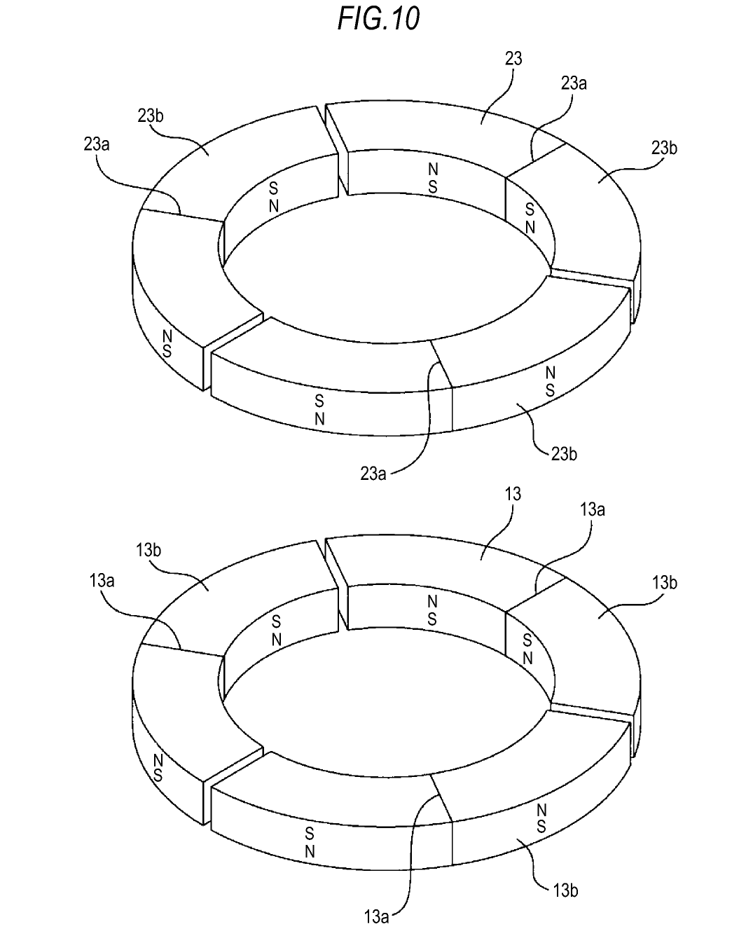

It is also preferable that the magnetic body 13 and the movable magnet 23 are respectively formed by plural members 13d, 13d, . . . and plural members 23b, 23b, . . . separated in the circumferential direction as shown in FIG. 10.

Though the example in which six-poles are magnetized in the circumferential direction in the movable magnet 23 and the magnetic body 13 has been shown as the above, it is not limited to the structure in which six-poles are magnetized in the movable magnet 23 and the magnetic body 13 as long as plural poles are magnetized.

### [Operation of Operation Device]

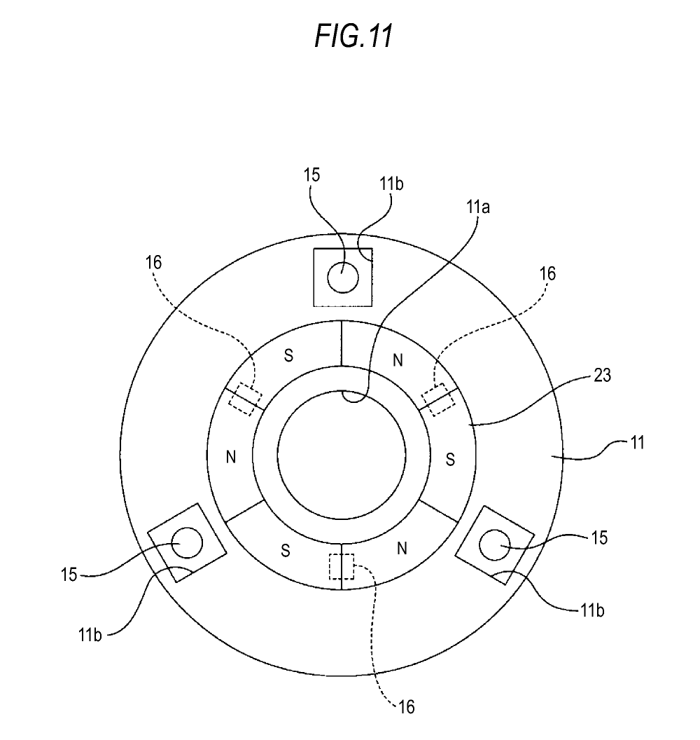

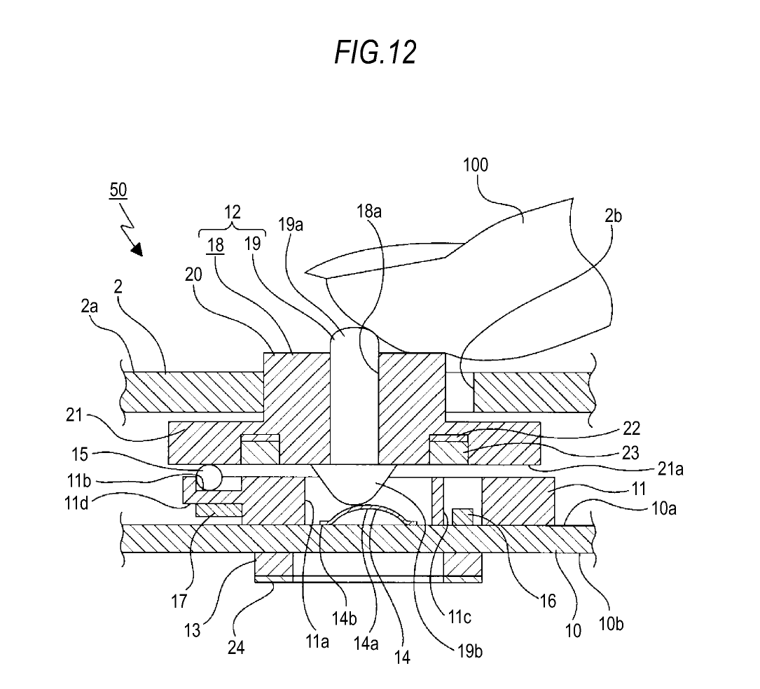

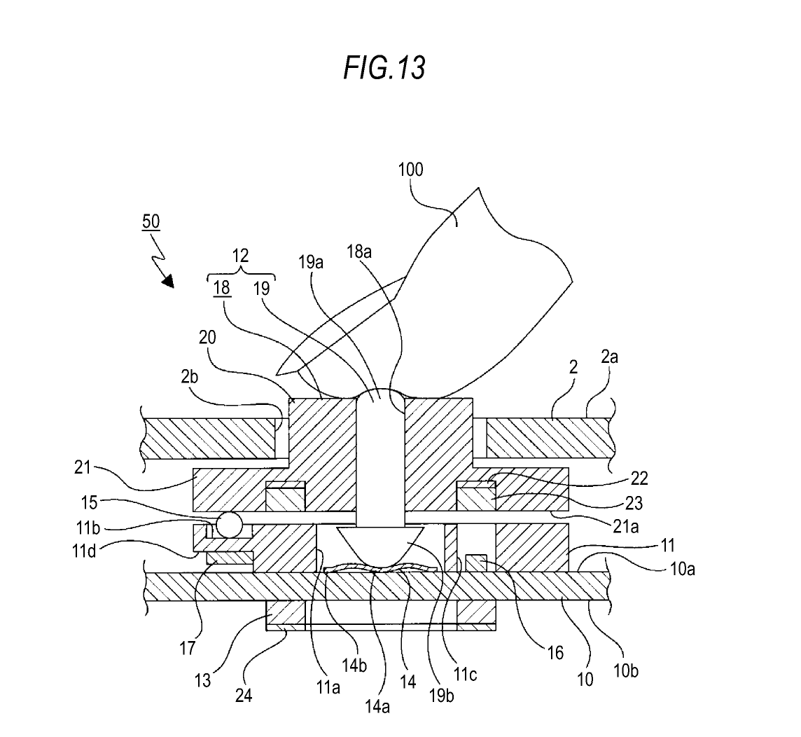

Hereinafter, operation performed when the operation device 50 is operated will be explained (see FIG. 3, FIG. 11, FIG. 12 and FIG. 13).

First, a state before the operation device 50 is operated will be explained (see FIG. 3).

In the state before the operation device 50 is operated, the operated body 18 and the pressed operation portion 19 are not operated, therefore, the key top 12 is in the initial position and the pressed operation portion 19 is in the non-operation position at the upper movement end.

The initial position is a position where N-poles and S-poles of the movable magnet 23 are pulled to S-poles of N-poles of the magnetic body 13 respectively so that the neutral lines 23a, 23a, . . . of the movable magnet 23 correspond to the neutral lines 13a, 13a, . . . of the magnetic body 13 in the up-and-down direction, that is, the central axis of the movable magnet 23 corresponds to the central axis of the magnetic body 13. At this time, the hall devices 16, 16 and 16 are positioned respectively between the neutral lines 23a, 23a, . . . and the neutral lines 13a, 13a, . . . corresponding to one another in the up-and-down direction (see FIG. 11).

The pressed operation portion 19 in the non-operation position touches the center of the plate spring 14 at the lower end thereof, and the controlled portion 19b touches the lower surface of the operated body 18.

When the operated body 18 is operated by a finger 100 manually, the key top 12 is moved in a radial direction, namely, in a direction orthogonal to an axial direction of the pressed operation portion 19 on the basis of the initial position (see FIG. 12). When the operated body 18 is moved, the spheres 15, 15 and 15 are rolled or slid in the concave portions for arrangement 11b, 11b and 11b of the housing 11 respectively by a frictional force between the lower surface 21a of the key top 12 and the housing 11.

Accordingly, the key top 12 is smoothly moved when the operated body 18 is operated, which improves operationality.

As excessive movement of the spheres 15, 15 and 15 are controlled by the concave portions for arrangement 11b, 11b and 11b, the contact state between the spheres 15, 15 and 15 and the key top 12 is not released and good operationality of the key top 12 can be constantly secured.

The movable magnet 23 is moved with the key top 12 as one body when the operated body 18 is operated as described above, therefore, a magnetic field formed between the movable magnet 23 and the magnetic body 13 is changed and output of the hall devices 16, 16 and 16 is changed according to the change of the magnetic field. Therefore, calculation processing is performed in a not-shown calculation unit (microcomputer) by output variation of the hall devices 16, 16 and 16 to thereby detect an operation position of the operated body 18, an operation direction of the operated body 18, movement speed of the operated body 18 and so on.

As described above, when the operated body 18 is operated, an arrow (cursor) displayed on, for example, the display screen of the television receiver is moved in a direction corresponding to the movement direction of the key top 12 by detection of the operation position of the operated body 18, the operation direction of the operated body 18 and so on.

When the operation with respect to the operated body 18 is completed and the finger 100 is taken off the operated body 18, the movable magnet 23 is pulled to the magnetic body 13 by absorptivity generated between the movable magnet 23 and the magnetic body 13. Therefore, the key top 12 returns to the initial position in which neutral lines 23a, 23a, . . . of the movable magnet 23 correspond to the neutral lines 13a, 13a, . . . of the magnetic body 13 in the up-and-down direction (see FIG. 3).

At this time, the spheres 15, 15 and 15 are rolled or slid in the concave portions for arrangement 11b, 11b and 11b of the housing 11 with the movement of the key top 12. The spheres 15, 15 and 15 are pulled to the center of the concave portions for arrangement 11b, 11b and 11b by the magnets for positioning 17, 17 and 17 respectively.

As described above, as the magnets for positioning 17, 17 and 17 positioning the spheres 15, 15 and 15 to the concave portions for arrangement 11b, 11b and 11b are provided in the operation device 50, the spheres 15, 15 and 15 are not rolled independent of the operation with respect to the operated body 18, as a result, a fixed operating feeling is constantly secured at the time of operating the key top 12 and the operationality is improved.

Additionally, different poles are alternately magnetized in the circumferential direction in the movable magnet 23 and the magnetic body 13 in the operation device 50.

Accordingly, a stable movement state to the initial state is secured while simplifying the structure of the movable magnet 23 and the magnetic body 13 as well as reducing the size thereof, which can improve reliability in operation of the operation device 50.

Subsequently, when the pressed operation portion 19 is press-operated by the finger 100 manually, the pressed operation portion 19 is moved downward (FIG. 13). When the pressed operation portion 19 is moved downward, the elastic deformation portion 14a of the plate spring 14 is pressed by the pressed operation portion 19, the elastic deformation portion 14a is elastically deformed, the connection portion 14b is allowed to touch plural connection terminals formed on the circuit substrate 10 and respective connection terminals are connected to one another by the plate spring 14. At this time, the pressed operation portion 19 is moved to the operation position.

The operation of the pressed operation portion 19 is, for example, a click operation with respect to icons displayed on the display screen of the television receiver. When the pressed operation portion 19 is operated, a function given to the icon to which the arrow has been moved on the display screen of the television receiver is executed.

When the operation with respect to the pressed operation portion 19 is competed and the finger 100 is taken off the pressed operation portion 19, the elastic deformation portion 14a of the plate spring 14 is elastically returned and the pressed operation portion 19 is moved upward to thereby return to the non-operation position as the original position before operated (see FIG. 3).

As described above, the pressed operation portion 19 is provided in the key top 12 of the operation device 50 so as to be move freely in the operated body 18, in which different processing from processing by operation of the operated body 18 is performed when moved to the operation position.

Accordingly, as different processing is performed in accordance with the operation by the operated body 18 in the key top 12 and the operation by the pressed operation portion 19 in the key top 12, the operationality is improved while downsizing the operation device 50.

The plate spring 14 is elastically deformed and plural connection terminals are connected to one another when the pressed operation portion 19 is operated, and the plate spring 14 is elastically returned and the pressed operation portion 19 is moved to the non-operation position when the operation with respect to the pressed operation portion 19 is released.

Accordingly, as the plate spring 14 has two functions which are a function of connecting plural connection terminals and a function of moving the pressed operation portion 19 to the non-operation position, a good operation state of the pressed operation portion 19 can be secured with the simple mechanism while reducing the number of components.

[Example of Different Operation Directions and so on]

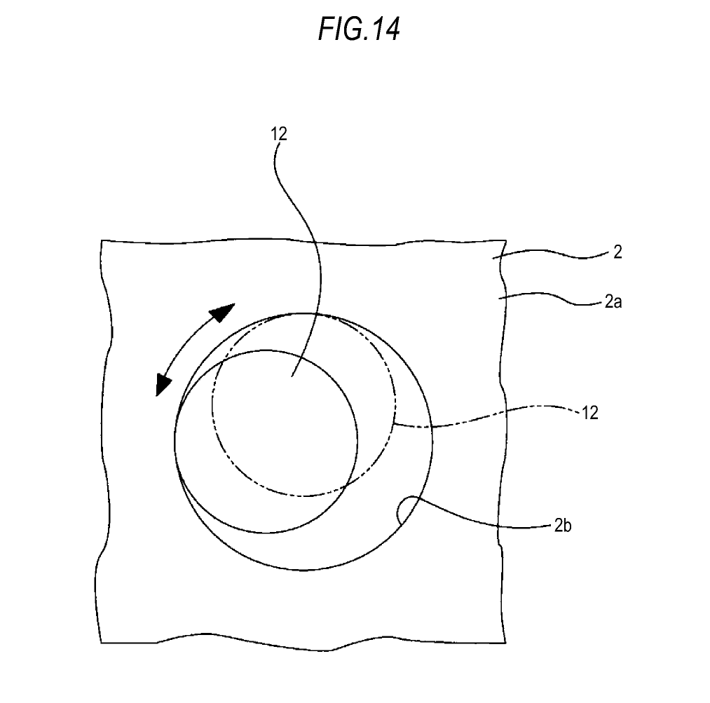

The example in which the key top 12 (operated body 18) is moved in the radial direction at the time of operation has been shown as the above, and it is also possible to have a structure in which the key top 12 is moved in a different direction from the radial direction in the operation device 50 as described below (see FIG. 14 to FIG. 20).

For example, it is possible to have a structure in which the key top 12 is moved in the circumferential direction along the shape (circular shape) of the key arrangement hole 2b formed in the casing 2 (see FIG. 14). When the key top 12 has the above structure, the position, the movement direction and the like of the key top 12 in the circumferential direction are detected by the hall devices 16, 16 and 16 and given processing is executed in accordance with the operation of the key top 12, therefore, the operation device 50 functions as, for example, an encoder.

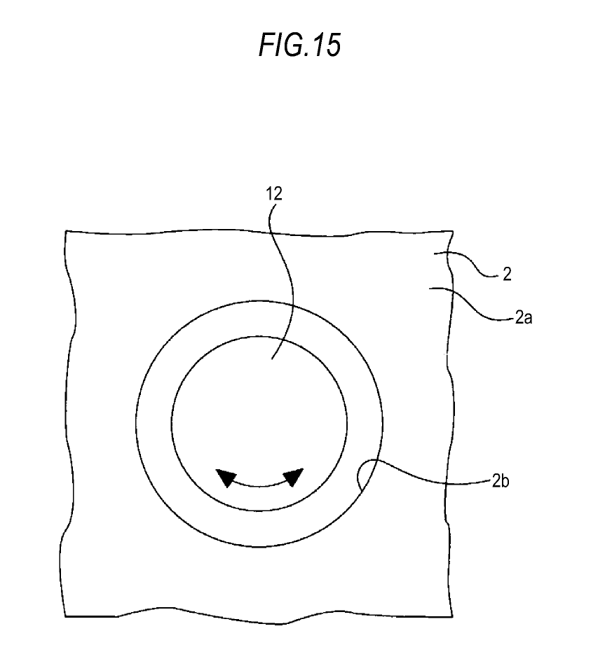

It is also possible to have a structure in which the key top 12 is rotated in the initial position (see FIG. 15). When the key top 12 has the above structure, a rotation direction, a rotation angle and so on of the key top 12 are detected by the hall devices 16, 16 and 16 and given processing is executed in accordance with the operation of the key top 12, therefore, the operation device 50 functions as, for example, the encoder.

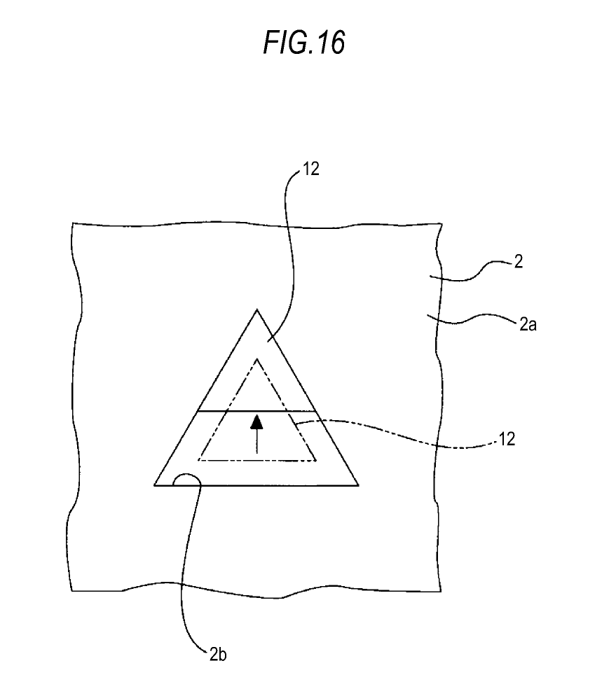

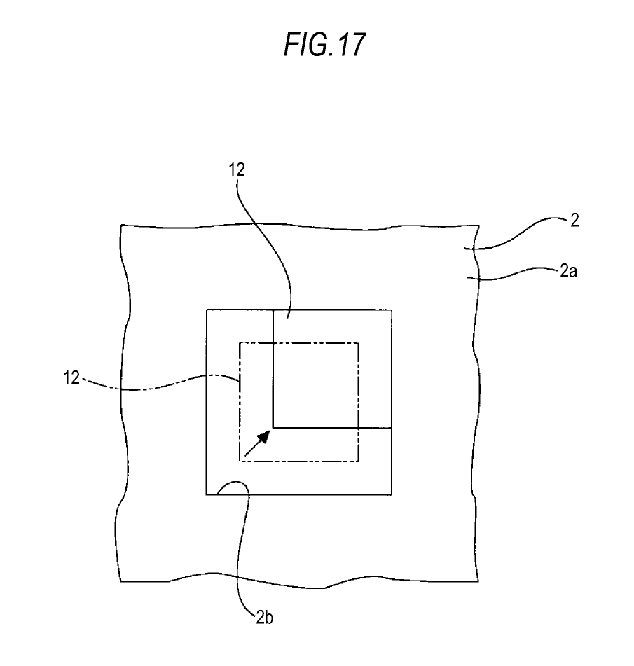

It is further possible to have a structure in which the key top 12 is moved in an arbitrary direction in the horizontal direction when the key arrangement hole 2b is formed in other shapes other than the circular shape, for example, a triangular shape (see FIG. 16) or a quadrangular shape (see FIG. 17). When the key top 12 has the above structure, the movement position, the movement direction and so on of the key top 12 are detected by the hall devices 16, 16 and 16 and given processing is executed in accordance with the operation of the key top 12.

When the key top 12 is formed in the triangle shape or the quadrangular shape so as to correspond to the key arrangement hole 2b in the above case, it is possible to position the key top 12 in the key arrangement hole 2b when the key top 12 moved to a corner of the key arrangement hole 2b (see the key top shown by solid lines in FIG. 16 and FIG. 17). When the key top 12 is positioned in this manner, operationality is improved as well as reliability in operation is improved as the key top 12 is positively moved to a necessary position.

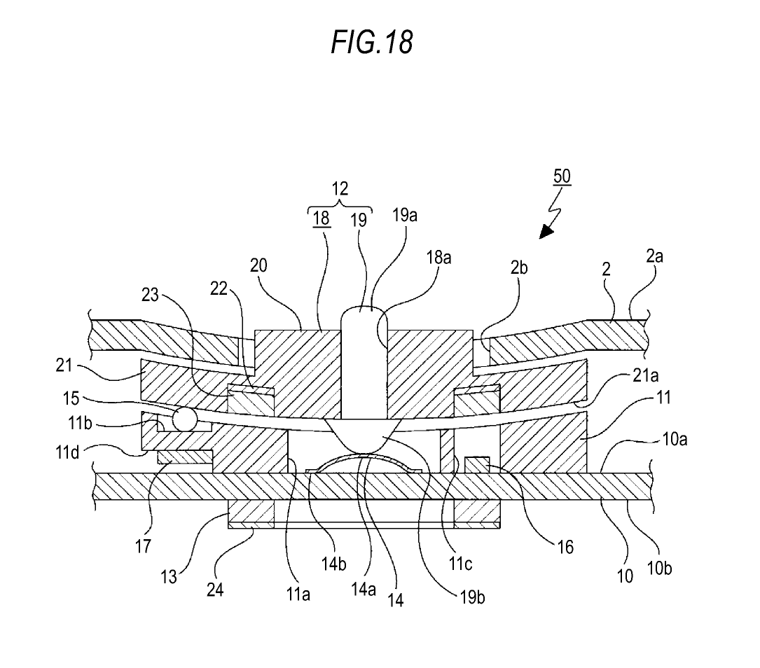

Furthermore, it is possible to have a structure in which the key top 12 is moved in directions along a spherical surface by forming the upper surface of the housing 11 and the lower surface of the key top 12 in a spherical shape respectively (see FIG. 18). When the key top 12 has the above structure, the movement position, the movement direction and so on of the key top 12 are detected by the hall devices 16, 16 and 16 and given processing is executed in accordance with the operation of the key top 12.

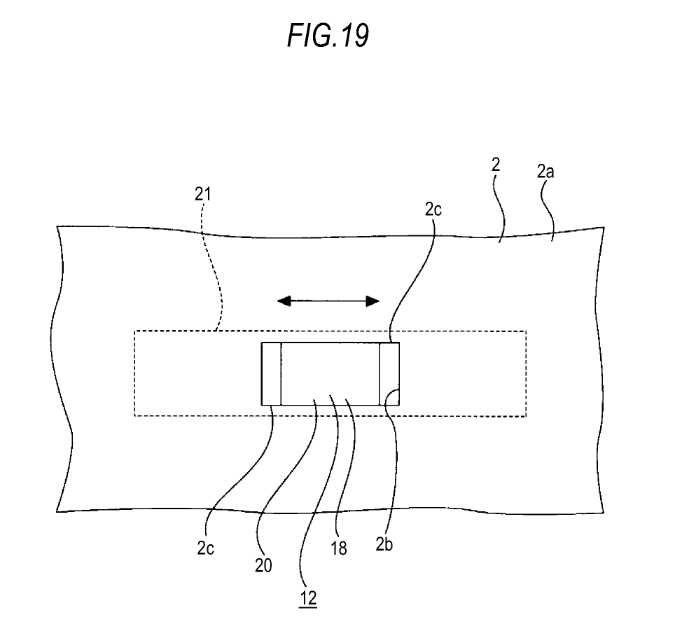

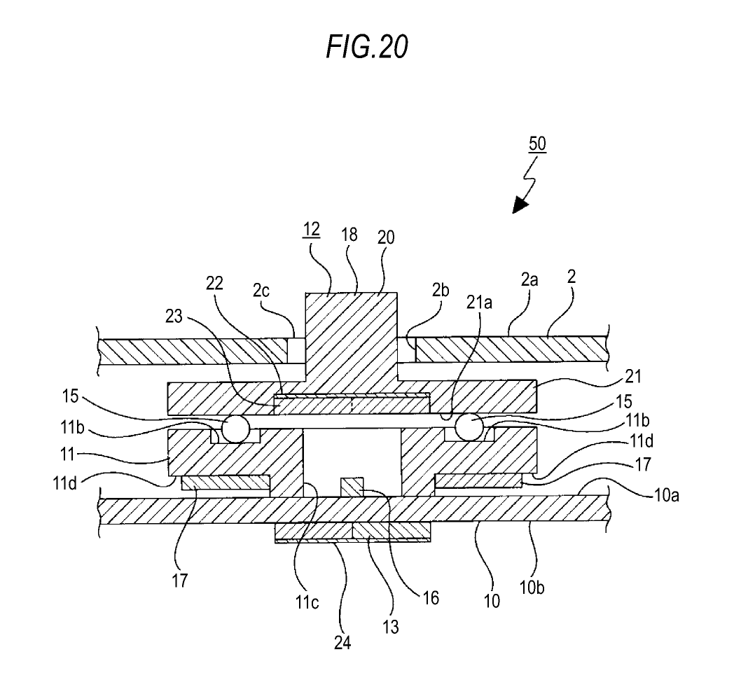

It is also possible to have a structure in which the key top 12 is moved to two directions in which the key arrangement hole 2b extends on the basis of the initial position when the key arrangement hole 2b is formed in a straight-line shape extending in a given direction (see FIG. 19 and FIG. 20). In the example of the operation device 50 shown in FIG. 19 and FIG. 20, the N-pole and the S-pole of the movable magnet 23 are magnetized in a right and left direction. The central hole of the housing 11 is formed as the device arrangement hole 11c and the hall device 16 is arranged in the device arrangement hole 11c.

In the above structure, for example, in the case where the pressed operation portion 19 is not provided, only one hall device 16 is provided at the center of the housing 11 and two spheres 15, 15 are arranged facing to each other by sandwiching the hall device 16 in the movement direction of the key top 12. Accordingly, the operation device 50 can be formed with a simple structure.

When the key top 12 has the above structure, the movement position, the movement direction and so on of the key top 12 are detected by the hall devices 16, 16 and 16 and given processing is executed in accordance with the operation of the key top 12. As the key top 12 is positioned at both end portions of the key arrangement hole 2b, operationality is improved as well as reliability in operation is improved as the key top 12 is positively moved to a necessary position.

Additionally, when the structure in which the key top 12 is moved in two directions is applied, opening edges 2c, 2c extending in the longitudinal direction of the key arrangement hole 2b can be formed as a guide portion for preventing the slant of the key top 12.

### [Modification Example of Operation Device]

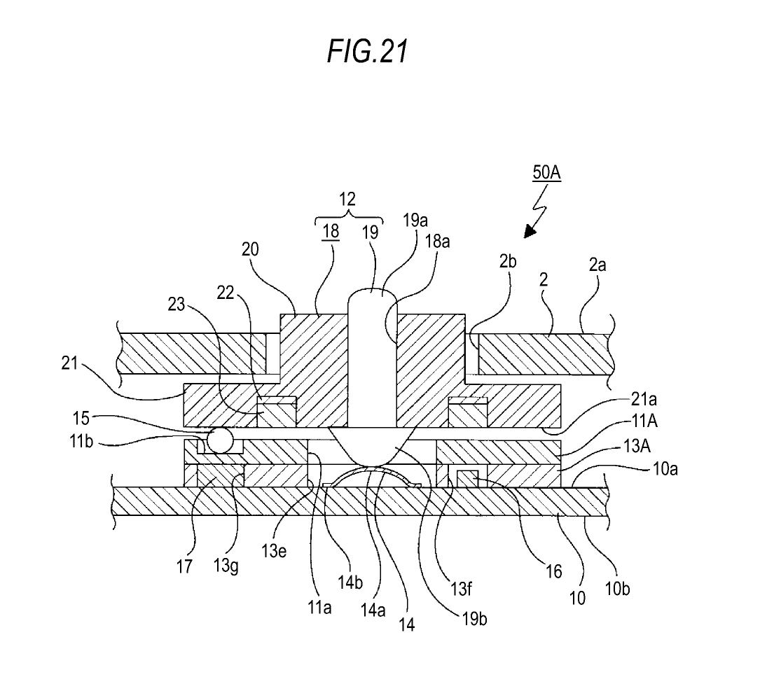

Hereinafter, a first modification example, a second modification example, a third modification example, a fourth modification example and a fifth modification example of the operation device will be explained (see FIG. 21 to FIG. 27).

In respective modification examples shown below, the yoke member coupled to the magnetic body may be provided, however, a structure in which the yoke member is not provided will be shown below.

First, the first modification example will be explained (see FIG. 21).

As an operation device according to the first modification example shown below differs from the above operation device 50 only in a point that arrangement positions of some of members are different, only portions different from the operation device 50 will be explained in detail, and the other portions are denoted by the same numerals and signs as the similar portions in the operation device 50 and explanation thereof will be omitted.

An operation device 50A according to the first modification example is formed by respective portions arranged on the upper surface 10a side of the circuit substrate 10, including a housing 11A, the key top 12 and a magnetic body 13A.

The housing 11A is formed in an approximately ring shape, which is arranged on the upper surface 10a side of the circuit substrate 10. A central hole of the housing 11A is formed as an insertion hole 11a. The concave portions for arrangement 11b, 11b and 11b opening upward are formed in an outer peripheral portion of the housing 11A, and the concave portions for arrangement 11b, 11b and 11b are positioned apart from one another at equal intervals in a circumferential direction.

In the concave portions for arrangement 11b, 11b and 11b of the housing 11A, the spheres 15, 15 and 15 made of a magnetic material are respectively arranged so as to be rolled. The sphere 15 can be moved in an arbitrary direction by being rolled in the concave portion for arrangement 11b, in which part thereof protrudes upward from the concave portion for arrangement 11b.

The magnetic body 13A is attached to the upper surface 10a of the circuit substrate 10, and the housing 11A is attached to the upper surface of the magnetic body 13A. A magnetic material such as a magnet or iron is used for the magnetic body 13A. The magnetic body 13A is formed in the ring shape.

The central hole of the magnetic body 13A is formed as a spring arrangement hole 13e. In the magnetic body 13A, device arrangement holes 13f, 13f and 13f and magnet arrangement holes 13g, 13g and 13g are alternately formed apart from one another in the circumferential direction. The hall devices 16, 16 and 16 are respectively arranged in the device arrangement holes 13f, 13f and 13f. The magnets for positioning 17, 17 and 17 are respectively arranged in the magnet arrangement holes 13g, 13g and 13g. The magnets for positioning 17, 17 and 17 are respectively arranged just under the concave portions for arrangement 11b, 11b and 11b of the housing 11A.

The magnetic body 13A is arranged below the housing 11A so that the central axis of the spring arrangement hole 13e corresponds to the central axis of the insertion hole 11a.

As described above, respective portions are arranged on the upper surface 10a side of the circuit substrate 10 in the operation device 50A, therefore, space under the lower surface 10b side of the circuit substrate 10 can be effectively utilized as arrangement space of other components of the electronic apparatus 1.

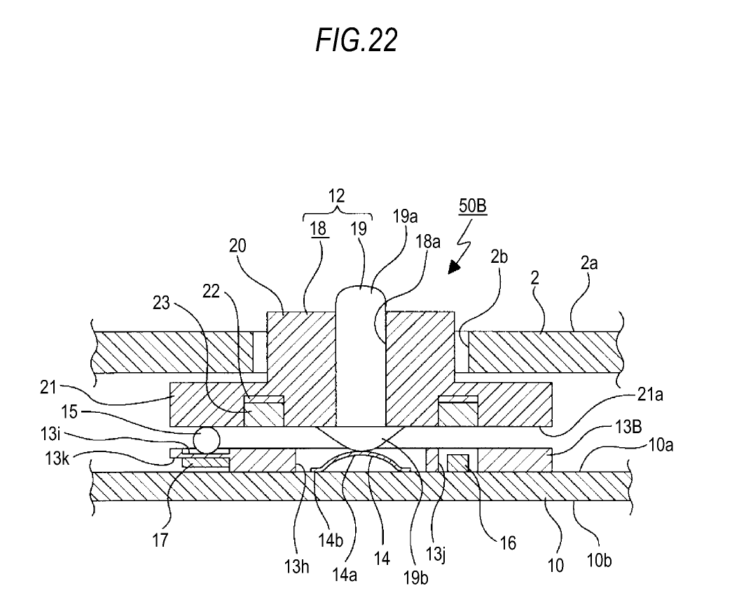

Next, the second modification example will be explained (see FIG. 22).

As an operation device according to the second modification example shown below differs from the above operation device 50 only in points that the housing is not provided and that arrangement positions of some of members are different, only portions different from the operation device 50 will be explained in detail, and the other portions are denoted by the same numerals and signs as the similar portions in the operation device 50 and explanation thereof will be omitted.

An operation device 50B according to the second modification example is formed by respective portions arranged on the upper surface 10a side of the circuit substrate 10, including the key top 12 and a magnetic body 13B. The housing is not provided in the operation device 50B.

The magnetic body 13B is formed in an approximately ring shape, which is attached on the upper surface 10a of the circuit substrate 10. A magnetic material such as a magnet or iron is used for the magnetic body 13B. The central hole of the magnetic body 13B is formed as a spring arrangement hole 13h. Concave portions for arrangement 13i, 13i and 13i opening upward are formed in an outer peripheral portion of the magnetic body 13B. The concave portions for arrangement 13i, 13i and 13i are positioned apart from one another at equal intervals in the circumferential direction.

In the concave portions for arrangement 13i, 13i and 13i of the magnetic body 13B, the spheres 15, 15 and 15 respectively made of a magnetic material are arranged so as to be rolled. The sphere 15 can be moved in an arbitrary direction by being rolled in the concave portion for arrangement 13i, in which part thereof protrudes upward from the concave portion for arrangement 13i.

Device arrangement holes 13j, 13j and 13j piercing in the up-and-down direction are formed in an inner peripheral portion of the magnetic body 13B. The device arrangement holes 13j, 13j and 13j are positioned apart from one another at equal intervals in the circumferential direction. The concave portions for arrangement 13i, 13i and 13i and the device arrangement holes 13j, 13j and 13j are alternately arranged at equal intervals in the circumferential direction. The hall devices 16, 16 and 16 are arranged in the device arrangement holes 13j, 13j and 13j.

Attachment concave portions 13k, 13k and 13k are formed in an outer peripheral portion of the magnetic body 13B just under positions of the concave portions for arrangement 13i, 13i and 13i. The attachment concave portions 13k, 13k and 13k open downward and outward. The magnets for positioning 17, 17 and 17 are attached to the attachment concave portions 13k, 13k and 13k respectively.

As described above, as respective portions are arranged on the upper surface 10a side of the circuit substrate 10 in the operation device 50B, space under the lower surface 10b side of the circuit substrate 10 can be effectively utilized as arrangement space of other components of the electronic apparatus 1.

Additionally, as the magnetic body 13B is attached to the circuit substrate 10, and the device arrangement holes 13j, 13j and 13j in which the hall devices 16, 16 and 16 are respectively arranged are formed in the magnetic body 13B in the operation device 50B, the housing is not necessary, which simplifies the structure and reduces the thickness due to reduction of the number of components in the operation device 50B.

Additionally, as the magnetic body 13B is attached to the circuit substrate 10 and the spring arrangement hole 13h in which the plate spring 14 is arranged is formed in the magnetic body 13B in the operation device 50B, the housing is not necessary, which simplifies the structure and reduces the thickness due to reduction of the number of components in the operation device 50B.

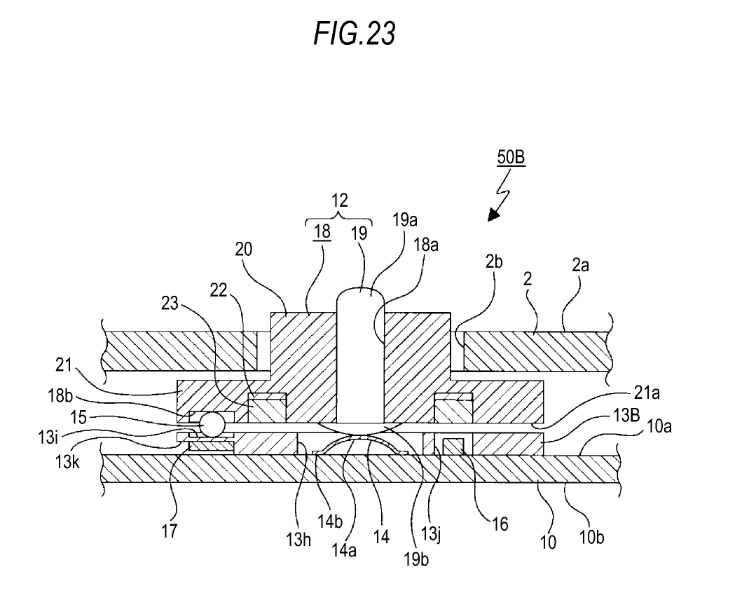

It is also possible to form concave portions for insertion 18b, 18b and 18b opening downward on a lower end portion of the operated body 18 of the key top 12 and to arrange the spheres 15, 15 and 15 so that part thereof are inserted into the concave portions for insertion 18b, 18b and 18b respectively in the operation device 50B as shown in FIG. 23.

The concave portions for insertion 18b, 18b and 18b into which part of the spheres 15, 15 and 15 are inserted are formed in the key top 12, thereby allowing the key top 12 to be close to the circuit substrate 10 by the depth of the concave portions for insertion 18b, 18b and 18b and further reducing the thickness of the operation device 50B.

The concave portions for insertion 18b, 18b and 18b as described above can be formed also in the above-described operation devices 50 and 50A. When the concave portions for insertion 18b, 18b and 18b are formed in the operation devices 50 and 50A, the thickness of the operation devices 50 and 50A can be reduced.

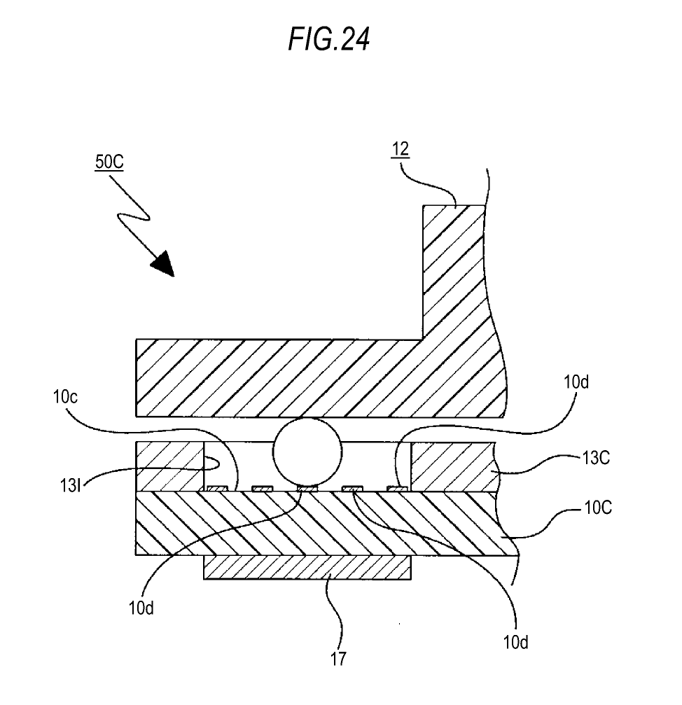

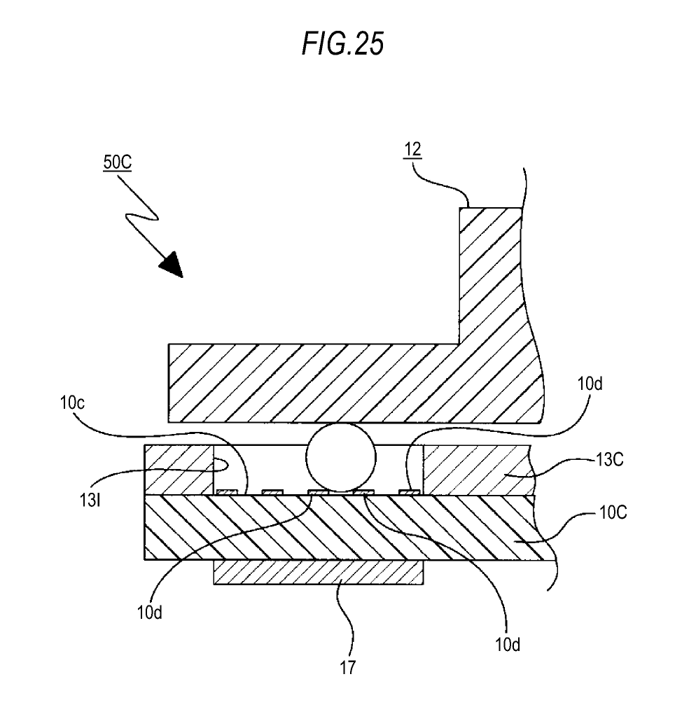

Next, the third modification example will be explained (see FIG. 24 and FIG. 25).

As an operation device according to the third modification example shown below differs from the above operation device 50 only in points that the housing is not provided and that arrangement positions and structures of some of members are different, only portions different from the operation device 50 will be explained in detail, and the other portions are denoted by the same numerals and signs as the similar portions in the operation device 50 and explanation will be omitted.

An operation device 50C according to the third modification example is formed by respective portions arranged on the upper surface 10a side and a lower surface 10b side of a circuit substrate 10C, including the key top 12 and a magnetic body 13C. The housing is not provided in the operation device 50C.

The magnetic body 13C is formed in an approximately ring shape, which is arranged on the upper surface 10a of the circuit substrate 10C. A magnetic material such as a magnet or iron is used for the magnetic body 13C. The central hole of the magnetic body 13C is formed as a not-shown spring arrangement hole. Arrangement holes 13l, 13l and 13l piercing in the up-and-down direction are formed at an outer peripheral portion of the magnetic body 13C. The arrangement holes 13l, 13l and 13l are positioned apart from one another at equal intervals in the circumferential direction.

The spheres 15, 15 and 15 respectively made of a magnetic material are arranged in the arrangement holes 13l, 13l and 13l of the magnetic body 13C so as to be rolled on the upper surface 10a of the circuit substrate 10C. The sphere 15 can be moved in an arbitrary direction by being rolled in the arrangement hole 13l, in which part thereof protrudes upward from the arrangement hole 13l.

In the circuit substrate 10C, portions in which the arrangement holes 13l, 13l and 13l exist are formed as sphere arrangement portions 10c, 10c and 10c respectively. Concentric traces 10d, 10d, . . . are formed in the sphere arrangement portions 10c, 10c and 10c respectively. The traces 10d, 10d, . . . are not formed as an electrical connection pattern, and are formed as portions functioning for slightly moving the spheres 15, 15 and 15 and the key top 12 in the vertical direction when the spheres 15, 15 and 15 are rolled.

Not-shown plural device arrangement holes piercing in the up-and-down direction are formed in an inner peripheral portion of the magnetic body 13C. The device arrangement holes are positioned apart from one another at equal intervals in the circumferential direction. The arrangement holes 13l, 13l and 13l and the plural device arrangement holes are alternately arranged at equal intervals in the circumferential direction. The hall devices 16, 16 and 16 are respectively arranged in the device arrangement holes.

The magnets for positioning 17, 17 and 17 are attached to the lower surface 10b of the circuit substrate 10C at positions just under the arrangement holes 13l, 13l and 13l.

When the operated body 18 of the key top 12 is operated and the spheres 15 are rolled in the operation device 50C, an operation of the sphere 15 climbing onto the trace 10d (see FIG. 24) and an operation of the sphere 15 falling between the traces 10d and 10d (see FIG. 25) are alternately performed repeatedly. Accordingly, the key top 12 is slightly moved in the vertical direction and the vertical movement is transmitted to the finger 100 of the operator as an operating feeling (clicking feeling).

As described above, as the concentric traces 10d, 10d, . . . are formed in the circuit substrate 10C in the operation device 50C, the operating feeing is transmitted to the finger 100 of the operator through the spheres 15, 15 and 15 as well as the key top 12, which gives the operator a good operating feeling.

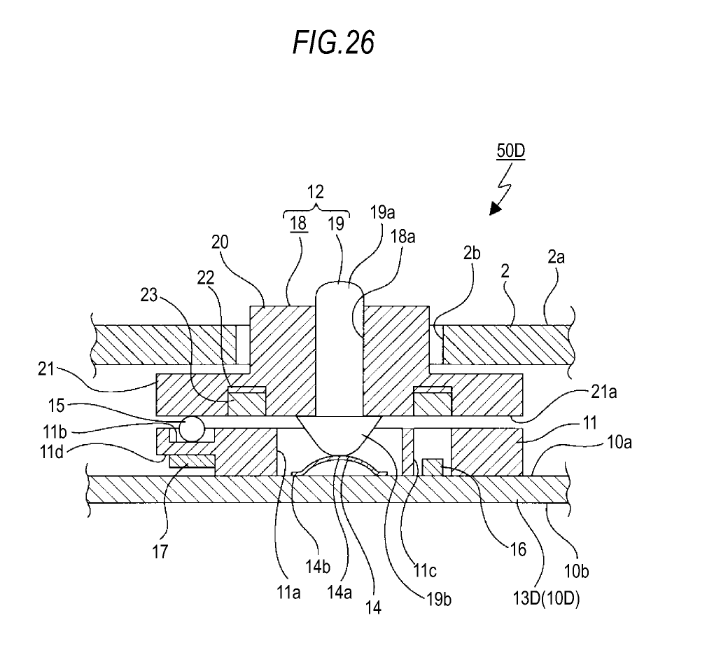

Next, the fourth modification example will be explained (see FIG. 26).

As an operation device according to the fourth modification example shown below differs from the above operation device 50 only in a point that the circuit substrate is provided also as a magnetic body and the magnetic body is not arranged on the lower surface side of the circuit substrate, only portions different from the operation device 50 will be explained in detail, and the other portions are denoted by the same numerals and signs as the similar portions in the operation device 50 and explanation will be omitted.

An operation device 50D according to the fourth modification example is formed by respective portions arranged on the upper surface 10a side of a circuit substrate 10D, including the housing 11, the key top 12 and a magnetic body 13D.

In the operation device 50D, the magnetic body 13D is provided as a base portion of the circuit substrate 10D. That is, the base portion of the circuit substrate 10D used as a base on which a circuit pattern is formed is made of a magnetic material to thereby formed as the magnetic body 13D. A non-conductive resist is coated on the magnetic body 13D and the circuit pattern is formed on the resist.

Accordingly, in the operation device 50D, the circuit substrate 10D functions also as the magnetic body 13D.

As described above, as the magnetic body 13D is provided also as the circuit substrate 10D in the operation device 50D, the number of components is small and the device can be downsized as well as the structure can be simplified.

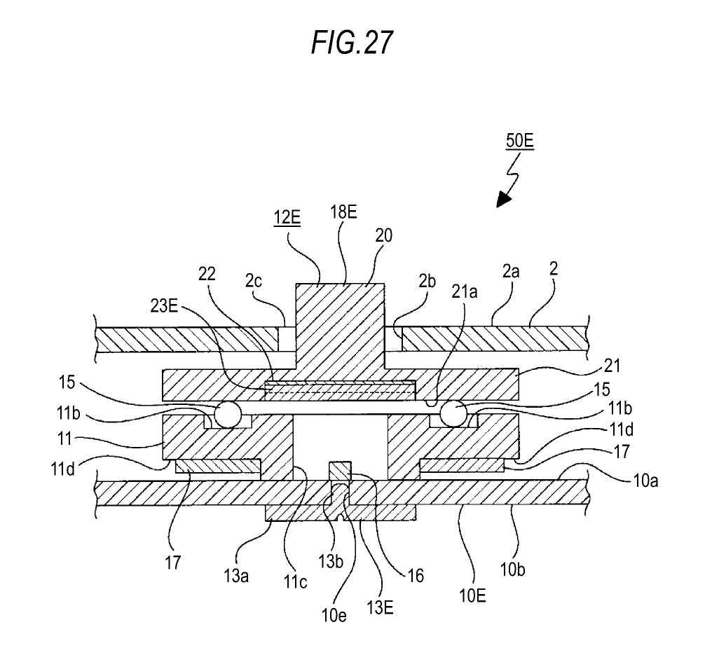

Next, the fifth modification example will be explained (see FIG. 27).

As an operation device according to the fifth modification example shown below differs from the above operation device 50 only in a point that part of the structure and the arrangement positions are different, only portions different from the operation device 50 will be explained in detail, and the other portions are denoted by the same numerals and signs as the similar portions in the operation device 50 and explanation will be omitted.

An operation device 50E according to the fifth modification example is formed by respective necessary portions arranged on both surfaces of the upper surface 10a and the lower surface 10b of a circuit substrate 10E.

A convex portion arrangement hole 10e is formed in the circuit substrate 10E.

The operation device 50E includes the housing 11, a key top 12E and a magnetic body 13E. The plate spring 14 is not arranged in the operation device 50E.

The housing 11 is formed in an approximately ring shape and the central hole thereof is formed as the device arrangement hole 11c. The hall device 16 is arranged in the device arrangement hole 11c of the housing 11, and the hall device 16 is positioned just above the convex portion arrangement hole 10e of the circuit substrate 10E.

The key top 12E has an operated body 18E, and the operated body 18E includes the operated portion 20 and the magnet attachment portion 21.

The yoke 22 and a movable magnet 23E are attached to the magnet attachment portion 21 so as to be coupled in the up-and-down direction. In the movable magnet 23E, the N-pole and the S-pole are magnetized in the up-and-down direction, namely, in the same direction as a direction in which the movable magnet 23E and the magnetic body 13E are aligned. The pressed operation portion 19 is not provided in the movable magnet 23E.

The key top 12E is arranged so that the operated portion 20 is inserted into the key arrangement hole 2b formed in the casing 2, and the lower surface 21a of the operated body 18E touches the spheres 15, 15 and 15 from above.

The magnetic body 13E is attached to the lower surface 10b of the circuit substrate 10E. A magnetic material such as a magnet or iron is used for the magnetic body 13E. The magnetic body 13E includes a plate-shaped base portion 13a facing the up-and-down direction and a convex portion 13b protruding upward from the center of the base portion 13a, which is attached to the circuit substrate 10E so that the convex portion 13b is inserted into the convex portion arrangement hole 10e from below.

When the magnet is used for the magnetic body 13E, the N-pole and the S-pole are magnetized in the up-and-down direction in the magnetic body 13E, that is, a pole on the upper side is magnetized different from a pole on the lower side of the movable magnet 23E.

The movable magnet 23E and the magnetic body 13E exist at positions facing each other in the up-and-down direction, and absorptivity occurs between them.

As the magnetic body 13E has the convex portion 13b protruding toward the movable magnet 23E, the density of magnetic flux generated by the movable magnet 23E and traversing the convex portion 13b is high, and a force to pull the movable magnet 23E in the convex portion 13b is the highest.

Before the operation device 50E is operated, the key top 12E is in the initial position in which the center of the movable magnet 23E is just above the convex portion 13b of the magnetic body 13E.

When the key top 12E is operated and moved, the movable magnet 23E is pulled to the magnetic body 13E due to absorptivity. As the convex portion 13b is provided in the magnetic body 13E, the key tope 12E is moved so that the center of the movable magnet 23E comes closest to the convex portion 13b in which a force to pull the movable magnet 23E is the highest when the operation with respect to the key top 12E is completed.

Accordingly, the key top 12E returns to the initial position again so that the center of the movable magnet 23E is positioned just above the convex portion 13b of the magnetic body 13E.

As described above, it is possible to return the key top 12E to the position before the operation positively when the operation with respect to the key top 12E is released in the operation device 50E.

Also in the operation device 50E, the hall device is positioned just above the convex portion 13b of the magnetic body 13E between the movable magnet 23E and the magnetic body 13E.

Accordingly, as magnetic flux with high density generated by the movable magnet 23E traverses the hall device 16, the sensitivity of detecting the hall device 16 is improved as well as the accuracy of detecting the position, the movement direction and the like of the key top 12E in the circumferential direction by the hall device 16 can be improved.

### [Others]

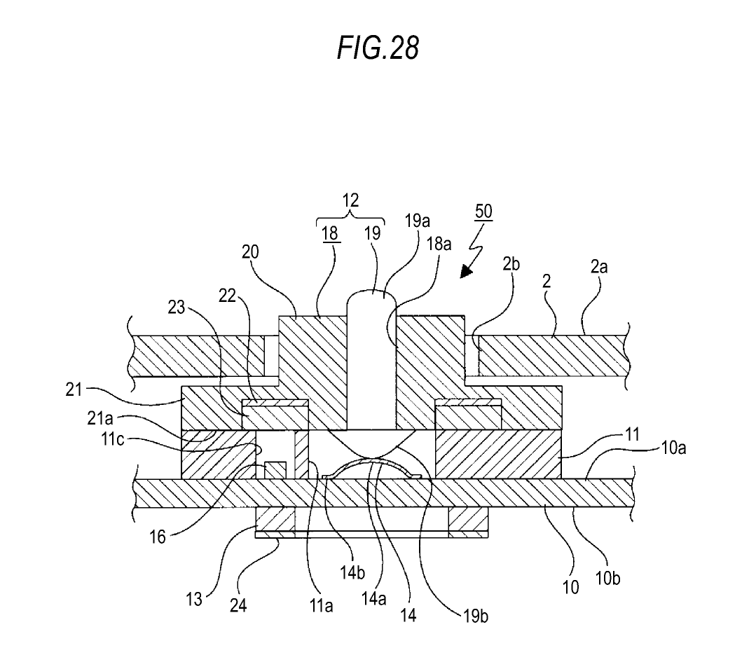

The example in which the operated body 18 is performed in a state where the key top 12 touches the spheres 15, 15 and 15 is shown as the above. It is also possible to have a structure in which the key top 12 is operated by being slid to the housing 11 or the magnetic bodies 13A, 13B, 13C and 13D without providing the spheres 15, 15 and 15 as shown in FIG. 28.

In the structure in which the spheres 15, 15 and 15 are not provided, a gap between the key top 12 and the housing or the magnetic bodies 13A, 13B, 13C and 13D is not necessary, which can reduce the thickness of the operation devices 50, 50A, 50B, 50C and 50D.

The number of spheres 15 and the hall devices 16 shown in the operation devices 50, 50A, 50B, 50C and 50D is an example and, the number of these members is arbitrary.

### [Brief]

As described above, the operation devices 50, 50A, 50B, 50C and 50D are provided with the magnetic bodies 13, 13A, 13B, 13C and 13D giving the force to move the key top 12 in the direction toward the initial position by absorptivity generated between the magnetic body and the movable magnet 23, and the hall device 16 mounted on the circuit substrates 10, 10C and 10D and detecting the movement state of the key top 12 due to the magnetic field generated in the movable magnet 23.

Accordingly, the key top 12 can be positively returned to the initial position when the operation of the key top 12 with respect to the operated body 18 is completed, therefore, reliability in operation can be improved while securing simplification in structure.

### [Present Technique]

The present technique may be implemented as the following structure.

(1) An operation device including

a key top arranged so that part thereof is inserted into a key arrangement hole formed in a casing of an electronic apparatus and being movable in a given direction on the basis of an initial position at the time of operation,

a movable magnet attached to the key top,

a magnetic body fixed so as to face the movable magnet and giving a force to move the key top in a direction toward the initial position by absorptivity generated between the magnetic body and the movable magnet,

a hall device detecting a movement state of the key top due to a magnetic field generated by the movable magnet, and

a circuit substrate on which the hall device is mounted.

(2) The operation device described in the above (1),

in which a circuit pattern to which the hall device is connected is formed on the magnetic body and the magnetic body is provided as the circuit substrate.

(3) The operation device described in the above (1),

in which

plural spheres positioned in a plane orthogonal to an axial direction of the key arrangement hole and capable of being rolled between the key top and the magnetic body are arranged,

the key top is moved in the given direction in a state of being pushed on the plural spheres and

the plural spheres are rolled with the movement of the key top.

(4) The operation device described in the above (3),

in which concave portions for arrangement opening toward the key top, in which the plural spheres are respectively arranged are formed.

(5) The operation device described in the above (4),

in which the spheres are made of a magnetic material and

magnets for positioning which position the spheres in the concave portions for arrangement are provided.

(6) The operation device described in the above (5),

in which the plural spheres and the magnets for positioning are arranged on an outer side or an inner side of the movable magnet and the magnetic body in the orthogonal plane.

(7) The operation device described in the above (1),

in which the magnetic body is attached to the circuit substrate,

a device arrangement hole is formed on the magnetic body and

the hall device is arranged in the device arrangement hole.

(8) The operation device described in the above (3),

in which concave portions for insertion opening toward the spheres are formed in the key top, and at least part of the spheres is inserted in the concave portions for insertion.

(9) The operation device described in the above (3),

in which part of the circuit substrate is formed as sphere arrangement portions in which the spheres are arranged, and

concentric traces are formed in the sphere arrangement portions.

(10) The operation device described in the above (1),

in which the key top includes an operated body movable in a direction orthogonal to the axial direction of the key arrangement hole and a pressed operation portion supported by the operated body so as to be movable in the axial direction of the key arrangement hole,

the pressed operation portion is moved between a non-operation position in which operation is not performed and an operation position in which operation is performed and given processing is performed, and

when the pressed operation portion is pushed and moved to the operation position, different processing from processing executed when the operated body is operated is performed.

(11) The operation device described in the above (10) in which

plural connection terminals are formed on the circuit substrate,

a plate spring having conductivity is arranged on the circuit substrate,

in which the plate spring is elastically deformed and touches the plural connection terminals when the pressed operation portion is operated to thereby connect the plural connection terminals to one another through the plate spring, and

the plate spring is elastically returned when the operation with respect to the pressed operation portion is released to thereby release the connection between the plural connection terminals as well as move the pressed operation portion to the non-operation position by the plate spring.

(12) The operation device described in the above (11),

in which the magnetic body is attached to the circuit substrate,

a spring arrangement hole is formed in the magnetic body and

the plate spring is arranged in the spring arrangement hole.

(13) The operation device described in the above (1),

in which a convex portion protruding toward the movable magnet is provided in the magnetic body, and

an N-pole and a S-pole of the movable magnet are magnetized in the same direction as a direction in which the movable magnet and the magnetic body are aligned.

(14) The operation device described in the above (1),

in which the movable magnet and the magnetic body are formed in a ring shape.

(15) The operation device described in the above (1),

in which different poles are alternately magnetized in a circumferential direction in the movable magnet, and

a magnet in which different poles are alternately magnetized in the circumferential direction is used as the magnetic body.

(16) An electronic apparatus including

a casing in which a key arrangement hole is formed,

a key top arranged so that part thereof is inserted into the key arrangement hole and being movable in a given direction on the basis of an initial position at the time of operation,

a movable magnet attached to the key top,

a magnetic body fixed so as to face the movable magnet and giving a force to move the key top in a direction toward the initial position by absorptivity generated between the magnetic body and the movable magnet,

a hall device detecting a movement state of the key top due to a magnetic field generated by the movable magnet, and

a circuit substrate on which the hall device is mounted.

Specific shapes and structures of respective portions shown in the above embodiment of the present disclosure are just examples for carrying out the present disclosure and the technical scope of the present disclosure should not be limitedly interpreted by the above examples.

It should be understood by those skilled in the art that various modifications, combinations, sub-combinations and alterations may occur depending on design requirements and other factors insofar as they are within the scope of the appended claims or the equivalents thereof.

What is claimed is:

1. An operation device comprising:
a key top arranged so that part thereof is inserted into a key arrangement hole formed in a casing of an electronic apparatus and being movable in a given direction on the basis of an initial position at the time of operation;
a movable magnet attached to the key top;
a magnetic body fixed so as to face the movable magnet and giving a force to move the key top in a direction toward the initial position by absorptivity generated between the magnetic body and the movable magnet;
a hall device detecting a movement state of the key top due to a magnetic field generated by the movable magnet; and
a circuit substrate on which the hall device is mounted.

2. The operation device according to claim 1,
wherein a circuit pattern to which the hall device is connected is formed on the magnetic body and the magnetic body is provided as the circuit substrate.

3. The operation device according to claim 1,
wherein plural spheres positioned in a plane orthogonal to an axial direction of the key arrangement hole and capable of being rolled between the key top and the magnetic body are arranged,
wherein the key top is moved in the given direction in a state of being pushed on the plural spheres and
the plural spheres are rolled with the movement of the key top.

4. The operation device according to claim 3,
wherein concave portions for arrangement opening toward the key top, in which the plural spheres are respectively arranged are formed.

5. The operation device according to claim 4,
wherein the spheres are made of a magnetic material and
magnets for positioning which position the spheres in the concave portions for arrangement are provided.

6. The operation device according to claim 5,
wherein the plural spheres and the magnets for positioning are arranged on an outer side or an inner side of the movable magnet and the magnetic body in the orthogonal plane.

7. The operation device according to claim 1,
wherein the magnetic body is attached to the circuit substrate,
a device arrangement hole is formed on the magnetic body and
the hall device is arranged in the device arrangement hole.

8. The operation device according to claim 3,
wherein concave portions for insertion opening toward the spheres are formed in the key top, and
at least part of the spheres is inserted in the concave portions for insertion.

9. The operation device according to claim 3,
wherein part of the circuit substrate is formed as sphere arrangement portions in which the spheres are arranged, and
concentric traces are formed in the sphere arrangement portions.

10. The operation device according to claim 1,
wherein the key top includes an operated body movable in a direction orthogonal to the axial direction of the key arrangement hole and a pressed operation portion supported by the operated body so as to be movable in the axial direction of the key arrangement hole,
the pressed operation portion is moved between a non-operation position in which operation is not performed and an operation position in which operation is performed and given processing is performed, and
when the pressed operation portion is pushed and moved to the operation position, different processing from processing executed when the operated body is operated is performed.

11. The operation device according to claim 10,
wherein plural connection terminals are formed on the circuit substrate,
a plate spring having conductivity is arranged on the circuit substrate,
the plate spring is elastically deformed and touches the plural connection terminals when the pressed operation portion is operated to thereby connect the plural connection terminals to one another through the plate spring, and
the plate spring is elastically returned when the operation with respect to the pressed operation portion is released to thereby release the connection between the plural connection terminals as well as move the pressed operation portion to the non-operation position by the plate spring.

12. The operation device according to claim 11,
wherein the magnetic body is attached to the circuit substrate,
a spring arrangement hole is formed in the magnetic body and
the plate spring is arranged in the spring arrangement hole.

13. The operation device according to claim 1,
wherein a convex portion protruding toward the movable magnet is provided in the magnetic body, and
an N-pole and a S-pole of the movable magnet are magnetized in the same direction as a direction in which the movable magnet and the magnetic body are aligned.

14. The operation device according to claim 1,
wherein the movable magnet and the magnetic body are formed in a ring shape.

15. The operation device according to claim 1,
wherein different poles are alternately magnetized in a circumferential direction in the movable magnet, and
a magnet in which different poles are alternately magnetized in the circumferential direction is used as the magnetic body.

16. An electronic apparatus comprising:
a casing in which a key arrangement hole is formed;
a key top arranged so that part thereof is inserted into the key arrangement hole and being movable in a given direction on the basis of an initial position at the time of operation;
a movable magnet attached to the key top;
a magnetic body fixed so as to face the movable magnet and giving a force to move the key top in a direction toward the initial position by absorptivity generated between the magnetic body and the movable magnet;
a hall device detecting a movement state of the key top due to a magnetic field generated by the movable magnet; and
a circuit substrate on which the hall device is mounted.
